(19) United States
(12) Patent Application Publication
(10) Pub. No.: US 2026/0162235 A1
(43) Pub. Date: Jun. 11, 2026

(54) IMAGE RESTORATION METHOD AND APPARATUS, AND DEVICE AND MEDIUM

(71) Applicant: BOE Technology Group Co., Ltd., Beijing (CN)

(72) Inventors: Ran Duan, Beijing (CN); Guannan Chen, Beijing (CN)

(73) Assignee: BOE Technology Group Co., Ltd., Beijing (CN)

(21) Appl. No.: 19/126,709

(22) PCT Filed: Sep. 26, 2023
(86) PCT No.: PCT/CN2023/121760

§ 371 Date: May 2, 2025

(30) Foreign Application Priority Data
Nov. 25, 2022 (CN) 202211490963.5

(51) Int. Cl. G06T 5/77; G06T 5/50; G06T 7/20; G06V 10/80

(52) U.S. Cl. CPC G06T 5/77; G06T 5/50; G06T 7/20; G06V 10/806

(57) ABSTRACT

An image restoration method includes: for a plurality of consecutive frames of images of a target video, acquiring an optical flow image between an image to be restored and each of a plurality of reference images; wherein the plurality of reference images comprise at least a previous frame image and a next frame image that are adjacent to the image to be restored; based on the optical flow image between each of the plurality of reference images and the image to be restored, performing motion estimation from the reference image to a moment of the image to be restored, to obtain a motion estimation image; and restoring defects of the image to be restored based on motion estimation images respectively corresponding to the plurality of reference images, to obtain a restored target image; wherein the defects comprise at least a defect of a bad pixel type.

The present disclosure claims the priority of the Chinese Patent application filed on Nov. 25, 2022 before the CNIPA, China National Intellectual Property Administration with the application number of 202211490963.5, and the title of “IMAGE RESTORATION METHOD AND APPARATUS, AND DEVICE AND MEDIUM”, which is incorporated herein in its entirety by reference.

### TECHNICAL FIELD

The present disclosure relates to the technical field of image processing and more particularly, to an image restoration method and apparatus, a device, and a medium.

### BACKGROUND

Images captured with film may have issues such as bad pixels, noise, or color cast due to time or poor storage. In this way, there are random defects such as bad pixels and scratches in the image formed after digital conversion of the film.

### SUMMARY

The present disclosure provides an image restoration method, including:
for a plurality of consecutive frames of images of a target video, acquiring an optical flow image between an image to be restored and each of a plurality of reference images; wherein the plurality of reference images include at least a previous frame image and a next frame image that are adjacent to the image to be restored;
based on the optical flow image between each of the plurality of reference images and the image to be restored, performing motion estimation from the reference image to a moment of the image to be restored, to obtain a motion estimation image; and
restoring defects of the image to be restored based on motion estimation images respectively corresponding to the plurality of reference images, to obtain a restored target image; wherein the defects include at least a defect of a bad pixel type.

In some optional embodiments, the method further includes:
extracting feature maps of each of the plurality of reference images under a plurality of receptive fields, and transforming the feature maps under each of the plurality of receptive fields based on the optical flow image between the reference image and the image to be restored, to obtain inter-frame semantic features under the plurality of receptive fields;
wherein restoring defects of the image to be restored based on motion estimation images respectively corresponding to the plurality of reference images, to obtain a restored target image includes:
restoring the image to be restored based on the motion estimation images and the inter-frame semantic features respectively corresponding to the plurality of reference images, to obtain the target image.

In some optional embodiments, restoring the image to be restored based on the motion estimation images and the inter-frame semantic features respectively corresponding to the plurality of reference images, to obtain the target image includes:
performing feature fusion on the image to be restored and the motion estimation images respectively corresponding to the plurality of reference images, to restore the defects of the image to be restored and obtain a coarse restored feature map; and
performing feature correction on the coarse restored feature map based on the inter-frame semantic features respectively corresponding to the plurality of reference images, to obtain the target image.

In some optional embodiments, transforming the feature maps under each of the plurality of receptive fields based on the optical flow image between the reference image and the image to be restored, to obtain inter-frame semantic features under the plurality of receptive fields includes:
processing the optical flow image corresponding to the reference image at a plurality of scales, to obtain a sub-optical flow image corresponding to each of the plurality of scales; wherein different scales corresponding to different receptive fields;
mapping the feature maps under a corresponding receptive field based on the sub-optical flow image corresponding to each of the plurality of scales, to obtain the inter-frame semantic features.

In some optional embodiments, performing feature correction on the coarse restored feature map based on the inter-frame semantic features respectively corresponding to the plurality of reference images, to obtain the target image includes:
acquiring a plurality of inter-frame semantic features belonging to the same receptive field from the inter-frame semantic features respectively corresponding to the plurality of reference images; and
correcting the coarse restored feature map under the plurality of receptive fields based on a plurality of inter-frame semantic features respectively corresponding to the plurality of receptive fields, to obtain the target image.

In some optional embodiments, correcting the coarse restored feature map under the plurality of receptive fields based on a plurality of inter-frame semantic features respectively corresponding to the plurality of receptive fields, to obtain the target image includes:
iteratively performing first feature fusion multiple times in an order of preset sizes of the receptive fields, until the plurality of inter-frame semantic features of all receptive fields are fused, to obtain a second fusion feature; and
acquiring the target image based on the second fusion feature;
wherein in the first feature fusion of each time, performing feature fusion on the plurality of inter-frame semantic features of the receptive field corresponding to the first feature fusion of a current time and first fusion features outputted after performing the first feature fusion of a previous time.

In some optional embodiments, acquiring the target image based on the second fusion feature includes:
acquiring a part or all of the first fusion features, each of the first fusion features corresponding to one receptive field; and
iteratively performing second feature fusion, to obtain the target image; wherein when performing the second feature fusion each time, fusing features outputted after performing the second feature fusion of a previous time and the first fusion features under the receptive field corresponding to the second feature fusion of a current time.

In some optional embodiments, in the first feature fusion of two adjacent times, a size of the receptive field targeted by the first feature fusion of the previous time is less than a size of the receptive field targeted by the first feature fusion of a next time; and
in the second feature fusion of every two times, a size of the receptive field targeted by the second feature fusion of the previous time is greater than a size of the receptive field targeted by the first feature fusion of a next time.

In some optional embodiments, acquiring an optical flow image between an image to be restored and each of a plurality of reference images, and based on the optical flow image between each of the plurality of reference images and the image to be restored, acquiring a motion estimation image from the reference image to a moment of the image to be restored include:
inputting the plurality of reference images and the image to be restored into an optical flow network, and outputting the optical flow image between the image to be restored and each of the plurality of reference images by the optical flow network; and
based on each of the plurality of reference images and the optical flow image between the reference image and the image to be restored outputted by the optical flow network, mapping the reference image, to obtain the motion estimation image.

In some optional embodiments, further including:
restoring bad pixels in the image to be restored based on the plurality of reference images, to obtain a bad pixel restored image;
wherein restoring the image to be restored based on motion estimation images respectively corresponding to the plurality of reference images, to obtain a restored target image, includes:
restoring the bad pixel restored image based on the motion estimation images respectively corresponding to the plurality of reference images, to obtain the target image.

In some optional embodiments, restoring bad pixels in the image to be restored based on the plurality of reference images, to obtain a bad pixel restored image includes:
based on defect-free areas in the previous image and the next image that are adjacent to the image to be restored among the plurality of images, restoring an area corresponding to the defect-free areas in the image to be restored, to obtain the bad pixel restored image.

In some optional embodiments, restoring defects of the image to be restored based on motion estimation images respectively corresponding to the plurality of reference images, to obtain a restored target image includes:
restoring the defects of the image to be restored based on the plurality of reference images and the motion estimation images respectively corresponding to the plurality of reference images, to obtain the target image.

In some optional embodiments, acquiring an optical flow image between an image to be restored and each of a plurality of reference images includes:
inputting the image to be restored and the plurality of reference images into an optical flow network of an image restoration model, and outputting the optical flow image between the image to be restored and each of the plurality of reference images by the optical flow network;
wherein restoring defects of the image to be restored based on motion estimation images respectively corresponding to the plurality of reference images, to obtain a restored target image, includes:
inputting the image to be restored and the motion estimation images respectively corresponding to the plurality of reference images into a generative network of the image restoration model, to restore the defects of the image to be restored, to obtain the target image.

In some optional embodiments, extracting semantic features of each of the plurality of reference images, and performing inter-frame transformation on the semantic features based on the optical flow image between the reference image and the image to be restored, to obtain inter-frame semantic features includes:
inputting each of the plurality of reference images and the optical flow image corresponding to the reference image into a semantic network of an image restoration model, extracting the feature maps of the reference image under the plurality of receptive fields by the semantic network, and transforming the feature maps under each of the plurality of receptive fields based on the optical flow image, to obtain the inter-frame semantic features under the plurality of receptive fields;
wherein restoring defects of the image to be restored based on motion estimation images respectively corresponding to the plurality of reference images, to obtain a restored target image includes:
inputting the image to be restored, as well as the motion estimation images and the inter-frame semantic features respectively corresponding to the plurality of reference images into a generative network of the image restoration model, to restore the defects of the image to be restored, to obtain the target image.

In some optional embodiments, the generative network includes a feature concatenation module, as well as a primary fusion module and a secondary fusion module that are sequentially connected in series after the feature concatenation module; wherein the primary fusion module includes a plurality of first fusion units that are connected in series;
the feature concatenation module is configured for performing feature fusion on the image to be restored and the motion estimation images respectively corresponding to the plurality of reference images, to obtain a coarse restored feature map;
each of the plurality of first fusion units is configured for performing the feature fusion on a plurality of inter-frame semantic feature under one receptive field and a first fusion feature outputted by a previous first fusion unit; wherein different first fusion units correspond to the plurality of inter-frame semantic features under different receptive fields; and
the secondary fusion module is configured for outputting the target image based on a second fusion feature.

In some optional embodiments, the secondary fusion module includes a plurality of second fusion units that are sequentially connected in series, wherein an input end of one second fusion unit is connected to output ends of a previous second fusion unit and one first fusion unit;
each of the plurality of second fusion units is configured for fusing features outputted by the previous second fusion unit and the first fusion feature outputted by the corresponding first fusion unit, and inputting into a next second fusion unit; and
the last one of the plurality of second fusion units is configured for outputting the target image.

In some optional embodiments, the semantic network includes: a convolution module and a downsampling module; wherein the convolution module includes a plurality of convolution units that are sequentially connected in series, and the downsampling module includes a plurality of downsampling units; wherein
each of the plurality of convolution units is configured for performing feature extraction on features outputted by a previous convolution unit, wherein each of the plurality of convolution units is configured for performing the feature extraction on the reference image and inputting extracted feature maps into a corresponding downsampling unit; wherein different convolution units connect to different downsampling units, and different convolution units correspond to different receptive fields;
each of the plurality of downsampling units is configured for performing an downsampling operation on the optical flow image at a corresponding scale to obtain a sub-optical flow image based on the downsampling operation, and transforming the feature maps outputted by the corresponding convolution unit to obtain the inter-frame semantic feature.

An embodiment of the present disclosure further provides an image restoration apparatus, including:
an optical flow information acquisition module configured for, for a plurality of consecutive frames of images of a target video, acquiring an optical flow image between an image to be restored and each of a plurality of reference images; wherein the plurality of reference images include at least a previous frame image and a next frame image that are adjacent to the image to be restored;
a motion estimation module configured for, based on the optical flow image between each of the plurality of reference images and the image to be restored, performing motion estimation from the reference image to a moment of the image to be restored, to obtain a motion estimation image; and
a restoration module, configured for restoring defects of the image to be restored based on motion estimation images respectively corresponding to the plurality of reference images, to obtain a restored target image; wherein the defects include at least a defect of a bad pixel type.

An embodiment of the present disclosure further provides an electronic device, including a memory, a processor, and a computer program stored on the memory and executable on the processor, wherein the computer program, when executed by the processor, implements the image restoration method described as the above embodiments.

An embodiment of the present disclosure further provides a computer-readable storage medium, wherein a computer program stored thereon causes a processor to execute the image restoration method described as the above embodiments.

In the embodiments of the present disclosure, for a plurality of consecutive frames of images of the target video, acquiring the optical flow image between the image to be restored and each of the plurality of reference images; and then, based on the optical flow image between each of the plurality of reference images and the image to be restored, performing the motion estimation from the reference image to the moment of the image to be restored, to obtain the motion estimation image; and restoring the defects of the image to be restored based on the motion estimation images respectively corresponding to the plurality of reference images, to obtain the restored target image.

In this embodiment, the plurality of reference images include at least the previous frame image and the next frame image that are adjacent to the image to be restored, the optical flow image can reflect the amount of movement of pixels representing the same object in one frame of the video image to the next frame, that is, it can reflect the position and direction changes of the same pixel between two frames of the image. In this way, based on the optical flow image, the motion estimation can be performed from the reference image to the moment of the image to be restored, and the position and direction of each pixel in the reference image for the next frame can be estimated, thereby obtaining the motion estimation image. In this way, the motion estimation image can be compared with the image to be restored, and based on the plurality of motion estimation images, bad pixels, scratches, and the like in the image to be restored can be restored.

In addition, since the process of acquiring the optical flow image does not require a large amount of computational resources, when restoring the image to be restored based on the motion estimation image, the image to be restored can be restored based on the difference between the motion estimation image and the image to be restored, thereby accurately removing the scratches and improving the accuracy of restoration.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and understandable, the specific embodiments of the present disclosure are listed below.

### BRIEF DESCRIPTION OF THE DRAWINGS

In order to more clearly illustrate the technical solution of the embodiments of the present disclosure or related art, a brief introduction will be given to the accompanying drawings required to be used in the embodiments or the related art. It is obvious that the accompanying drawings described below are only some embodiments of the present disclosure. For those skilled in the art, other drawings may be obtained based on these drawings without creative work. It should be noted that the scale in the accompanying drawings is only for illustration and does not represent the actual scale.

FIG. 1 shows a schematic diagram of principle of an image restoration method according to the present disclosure;

FIG. 2 shows a flowchart of steps of an image restoration method according to an embodiment of the present disclosure;

FIG. 3 shows a schematic diagram of principle of restoring the image to be restored using the motion estimation images and the inter-frame semantic features according to an embodiment of the present disclosure;

FIG. 4 shows a schematic structural diagram of an image restoration model according to an embodiment of the present disclosure;

FIG. 5 shows a schematic structural diagram of an optical flow network according to an embodiment of the present disclosure;

FIG. 6 shows a schematic diagram of a process for obtaining motion estimation images according to an embodiment of the present disclosure;

FIG. 7 shows a schematic structural diagram of another image restoration model according to an embodiment of the present disclosure;

FIG. 8 shows a schematic diagram of input and output of a semantic network according to an embodiment of the present disclosure;

FIG. 9 shows a schematic structural diagram of a semantic network according to an embodiment of the present disclosure;

FIG. 10 shows a schematic structural diagram of a generative network according to an embodiment of the present disclosure;

FIG. 11 shows a schematic diagram of a framework structure of an image restoration apparatus according to an embodiment of the present disclosure; and

FIG. 12 shows a schematic diagram of a framework structure of an electronic device according to an embodiment of the present disclosure.

### DETAILED DESCRIPTION

In order to clarify the purpose, technical solution, and advantages of the embodiment of the present disclosure, a clear and complete description of the technical solution in this embodiment of the present disclosure will be provided below in conjunction with the accompanying drawings. Obviously, the described embodiments are a part of the embodiments of the present disclosure, not all the embodiments. Based on the embodiments of the present disclosure, all other embodiments obtained by persons skilled in the art without creative work are within the scope of protection of the present disclosure.

There are random defects such as bad pixels and scratches in the image formed after digital conversion of the film. In order to restore the images with the bad pixels and the scratches, the following method is adopted in related art: an median filtering operation is performed on three consecutive frames of images in the time domain, and then the image after the median filtering operation is sent to a multi-scale cascade network for restoring.

However, the multi-scale cascaded network is a network model with three Unet structures including 3D convolutions. This model extracts information between adjacent frames and fuses them through a 3D average pooling layer to estimate and compensate for inter-frame motion. The effectiveness of this method is limited by the perceptual domain range of the convolutional layer. When the resolution of the input image is large or the magnitude of motion between adjacent frames is large, it exceeds the coverage upper limit of the perceptual domain of the model and affects the restoration effect of artifacts. Generally speaking, the perceptual domain is expanded by increasing the convolution kernel size of the convolutional layers or by increasing the number of convolutional layers (deepening the depth of the network), that is, by deepening the depth of the network and continuously increasing the receptive field. However, when the model depth increases, there is an increase in the quantity of parameters and calculations, which not only consumes a lot of computing resources but also reduces processing efficiency.

However, this cannot be tolerated in the image restoration after the digital conversion of the film, as the data volume is generally large after the digital conversion of the film. If restoring defect images in each frame consumes a lot of time, it will undoubtedly take too long to restore images of the entire video, leading to an increase in conversion costs.

In view of this, the present disclosure provides an efficient image restoration method, which mainly utilizes the optical flow information between video images to perform motion estimation on the reference images adjacent to the image to be restored. That is to say, it estimates the motion estimation image of the reference image that exists in a continuous relationship with the image to be restored in time to the moment of the image to be restored. These motion estimation images can be compared with the image to be restored, so as to use the motion estimation image as a reference to restore defects in the image to be restored.

Since the optical flow image can reflect the position and direction changes of the same pixel between two frames of images, and these changes in position and direction can accurately reflect the magnitude of motion between adjacent frames, that is to say, when the magnitude of motion between adjacent frames is large, it is not limited by the size of the receptive field, and there is no need to deepen the depth of the model or introduce the unnecessary parameter quantities, reducing the consumption of computing resources and improving processing efficiency, thereby reducing the cost of restoring the image after the digital conversion of the film.

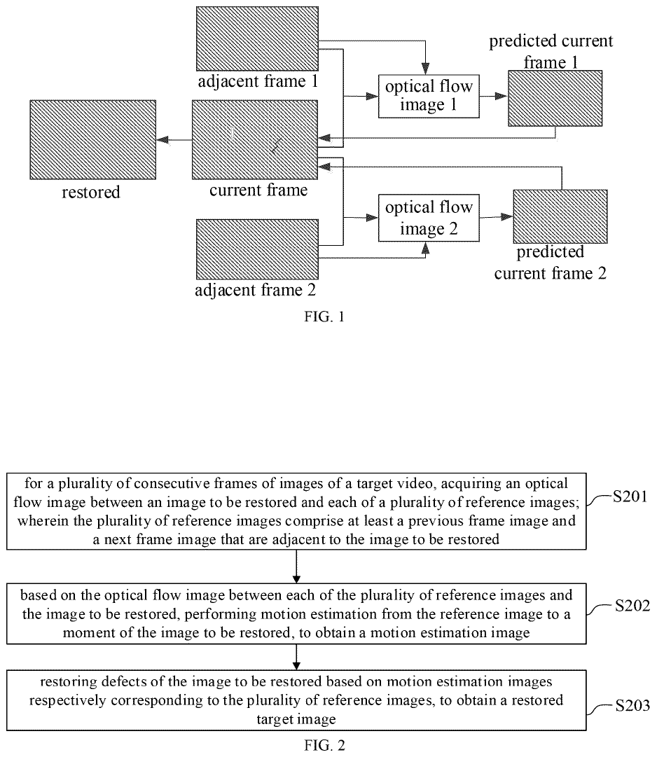

Referring to FIG. 1 and FIG. 2, FIG. 1 shows a schematic diagram of principle of an image restoration method in the present disclosure, and FIG. 2 shows a flowchart of the steps of an image restoration method in the present disclosure.

As shown in FIG. 1, the present disclosure aims to use the optical flow image between adjacent frames (i.e. the reference image) and the current frame (i.e. the image to be restored) to estimate a predicted current frame (i.e. the motion estimation image) from the previous and next adjacent frames to the current frame, and then use the predicted current frame to restore the current frame. The image in FIG. 1 is only an exemplary illustration and does not represent the actual video image. The defects in the current frame are illustrated using ellipses and lines in FIG. 1.

As shown in FIG. 2, the image restoration method of the present disclosure can be applied to video frame restoration in videos, which can be executed by an electronic device and can include the following steps:

Step S201: for a plurality of consecutive frames of images of a target video, acquiring an optical flow image between an image to be restored and each of a plurality of reference images.

The plurality of reference images include at least a previous frame image and a next frame image that are adjacent to the image to be restored.

The target video can be a video after the digitized conversion of the film, in which the video frame images converted from film with defects such as the bad pixels and the scratches can be marked, the marked video frame can be the image to be restored, and the plurality of consecutive video frames that are previous and next to the image to be restored can be used as the reference images. Among them, the plurality of reference images include at least the previous frame image and the next frame image that are adjacent to the image to be restored, that is to say, both the previous frame image and the next frame image of the image to be restored need to be used as the reference images. In some embodiments, the reference image may include not only the previous frame image and the next frame image of the image to be restored, but also n images located before the previous frame image and m images located after the next frame image.

That is to say, the plurality of reference images can include at least one consecutive video frame located before the image to be restored, and at least one consecutive video frame located after the image to be restored. Among them, n can be greater than or equal to 1, and m can also be greater than or equal to 1, where n can be equal to m, or n and m can be different.

It should be noted that regardless of how many reference images are included, the plurality of reference images and the image to be restored are multiple frames of images in the target video that are continuous in time. For example, the target video includes 1000 video frames in sequence, namely N₁˜N₁₀₀₀. Assuming that one image to be restored is the video frame N₈, video frames N₇ and N₉ can be used as the reference images, where the video frame N₇ is the previous frame image and the video frame N₉ is the next frame image. In another embodiment, video frames N₆, N₇, N₉, and N₁₀ can be used as the reference images.

Among them, the reference images and the image to be restored have a temporal continuity, in practice, this temporal continuity can be reflected in the image changes between the image to be restored and the reference images, and the image changes include image changes caused by camera movement, image changes caused by object movement, and image changes caused by the camera movement and the object movement. Therefore, in the case of continuous time, there is a certain correlation between the frames of the video, for example, the same object is involved in three consecutive frames, and the difference lies in the size, direction, and position of the same object.

Therefore, the optical flow image between the image to be restored and each reference image can be obtained, which can be used to depict the image correlation between the image to be restored and the reference image. The optical flow image includes the motion change information of the same pixel from the moment of the reference image to the moment of the image to be restored, and the motion change information can include changes in position and direction.

In this embodiment, the optical flow image can describe the motion changes from the reference image to the image to be restored. For each reference image, the optical flow image between it and the image to be restored can be obtained. In this way, the motion changes between the image to be restored and the reference images that have a temporal continuity with the image to be restored can be determined using the image to be restored as the center. Since it includes the reference image of the previous frame and the reference image of the next frame, it may simultaneously depict the image changes between the image to be restored and the reference image in both a forward direction and a reverse direction.

In practice, in the video, whether it moves to the image to be restored in the forward direction (moving forward in time), or moves to the image to be restored in the reverse direction (moving backward in time), the final image should be frozen to the image to be restored. In this way, when the reference image includes the previous frame and the next frame of the image to be restored, the motion estimation can be performed by combining the optical flow image from the previous frame to the image to be restored, and the optical flow image from the next frame to the image to be restored, to depict the motion estimation image at the moment when the image to be restored is located from different temporal directions, thereby providing a temporal reference for the image to be restored.

Step S202: based on the optical flow image between each of the plurality of reference images and the image to be restored, performing motion estimation from the reference image to a moment of the image to be restored, to obtain a motion estimation image.

Among them, for each reference image, the motion estimation image from the reference image to the moment of the image to be restored can be estimated. In specific implementation, the optical flow image between the reference image and the image to be restored can be used to transform the positions and directions of the pixels in the reference image, the transformed image is the estimated motion estimation image. The motion estimation image can be understood as an image obtained after predicting the position and shape of each object in the reference image at the next moment based on the optical flow image, and can be an image that can serve as a reference for the image to be restored.

Among them, since the reference image includes at least the previous frame image and the next frame image that are adjacent to the image to be restored, it may predict the motion estimation image 1 (the predicted current frame 1 in FIG. 1) from the previous frame image to the moment of the image to be restored, and the motion estimation image 2 (the predicted current frame 2 in FIG. 1) from the next frame image to the moment of the image to be restored. Among them, both the motion estimation image 1 and the motion estimation image 2 can serve as references for the image to be restored.

Generally speaking, since the defect areas included in the previous frame image and the defect areas included in the next frame image are different from the defect areas included in the image to be restored, the defect areas included in motion estimation image 1 and the motion estimation image 2 are different from the defect areas in the image to be restored. Thus, the motion estimation image 1 and the motion estimation image 2 can be used to restore the defect areas of the image to be restored.

Step S203: restoring defects of the image to be restored based on motion estimation images respectively corresponding to the plurality of reference images, to obtain a restored target image.

The defects include at least a defect of a bad pixel type.

As shown in FIG. 1, for each reference image, the motion estimation image corresponding to it can be understood as a predicted image of the image to be restored in a certain dimension. It should be noted that, the motion estimation is performed from the reference image to the moment of the image to be restored based on the optical flow image, and the similarity between the motion estimation images obtained is very high, and the similarity between each motion estimation image and the image to be restored is also very high. As mentioned above, the defect areas included in the motion estimation image 1 and the motion estimation image 2 are different from the defect areas included in the image to be restored, or in some cases, the motion estimation image 1 and the motion estimation image 2 do not have the defect areas. Therefore, based on the motion estimation image 1 and the motion estimation image 2, the defects in the image to be restored can be replaced, filled or corrected, thereby achieving the goal of restoring the image to be restored.

In some embodiments, based on the motion estimation images respectively corresponding to the plurality of reference images, restoring the defects in the image to be restored can be understood as performing feature fusing on each reference image and the image to be restored. During the feature fusion process, for pixels at the same position, the pixel values of the pixels at that position in the image to be restored can be adjusted according to the pixel values of the pixels at that position in each motion estimation image, to achieve the goal of restoring.

In some embodiments, when the reference image includes the previous frame image and the next frame image that are adjacent to the image to be restored, the temporal continuity between the reference image and the image to be restored is closer, and the image changes between the three frames are more logically correlated. Therefore, the motion estimation images estimated by the previous frame image and the next frame image are closer to the image to be restored, which can improve the restoration effect.

Certainly, in addition to including the previous frame image and the next frame image that are adjacent to the image to be restored, it also includes other video frames that are adjacent to the previous frame image and the next frame image. Therefore, the duration of time continuity is relatively long. Generally speaking, in the case of a long duration of time continuity, the variation amplitude of the distant view in the image is smaller than that of the close view. For example, the variation amplitude of the distant view in the video frames N₆˜N₁₀ are relatively small, while the variation amplitude of the close view are relatively large.

Therefore, the distant view in the reference image that is far away from the image to be restored can be used as a reference for the distant view of the image to be restored, so as to accurately restore the defects in the distant view of the image to be restored by using the distant view of multiple frames of reference images that are continuous with the image to be restored.

By adopting the technical solution of this embodiment, based on the optical flow image between the reference image and the image to be restored, the motion estimation images from the reference images to the moment of the image to be restored are estimated, and these motion estimation images can be compared with the image to be restored. Since the motion estimation images and the image to be restored can be basically understood as images taken by the same camera at the same time and position, the defect-free areas in the plurality of motion estimation images can be used to restore the defects in the image to be restored, thereby accurately removing the scratches and improving restoration accuracy.

Moreover, since the optical flow image can accurately reflect the size of the magnitude of motion between adjacent frames, that is to say, when the magnitude of motion between the adjacent frames is large, it is not limited by the size of the receptive field. Therefore, there is no need to deepen the depth of the model or introduce the unnecessary parameter quantities, so that the acquisition processes of the optical flow image and the motion estimation image do not consume a lot of computational resources, thereby improving processing efficiency.

To fully understand the implementation plan of the present disclosure, the image restoration method of the present disclosure will be described in detail below:

1. Three methods for restoring the image to be restored

(1) The first method: combining the motion estimation images with contextual inter-frame information between the image to be restored and the reference image, to restore the image to be restored.

In some embodiments, when restoring the image to be restored, in addition to restoring based on the motion estimation images from the reference image to the moment of the image to be restored, inter-frame information (hereinafter referred to as inter-frame semantic features) between the image to be restored and the reference image can also be used for restoration. This inter-frame information can include contextual semantic features between the image to be restored and the previous frame of reference image, or between the image to be restored and the next frame of reference image.

Among them, the inter-frame information can describe the related spatial features between the image to be restored and the reference image, that is, it reflects the changes in the detail content included in the reference image and the image to be restored. Based on this change in detail content, the detail content in the image to be restored can be restored. For example, when there are defects such as noise and the scratches in the image to be restored, the inter-frame information can be used to fill and repair the details, thereby achieving a more accurate restoration effect.

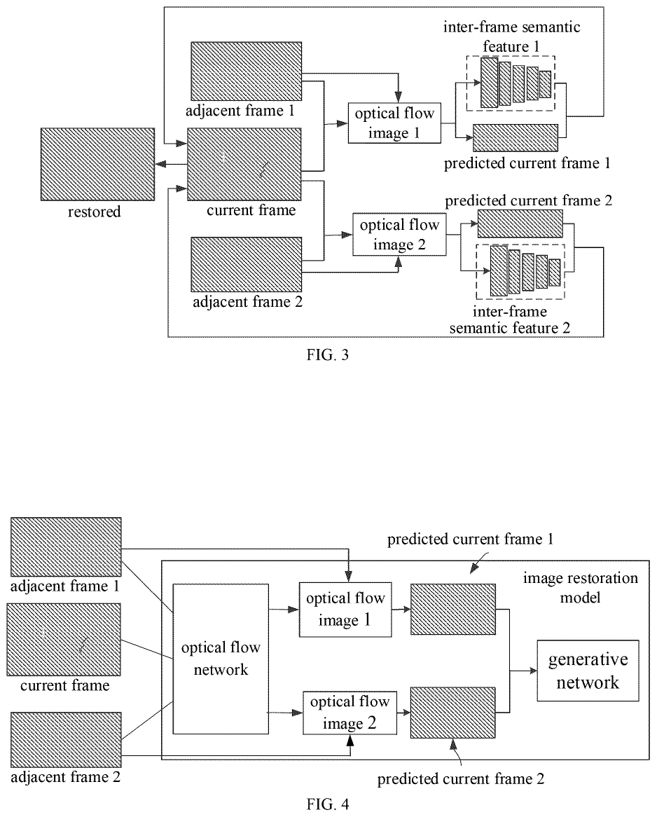

Referring to FIG. 3, a schematic diagram of principle of restoring the image to be restored using the motion estimation images and the inter-frame semantic features is shown. As shown in FIG. 3, the inter-frame semantic features can be obtained through the reference images and the optical flow image between the reference image and the image to be restored.

Among them, the optical flow image includes the position and motion changes of the same pixel between the reference image and the image to be restored. In practice, due to the abundance and complexity of details in the image, the receptive field of the reference image can be adjusted when obtaining the inter-frame semantic features, to construct the spatial features of the reference image in different fields of view. Then, based on the optical flow image, the spatial features of different fields of view can be mapped to the moment T of the image to be restored, thereby predicting the spatial features of different fields of view at the moment T.

Among them, the larger the field of view, the stronger the global features of the spatial features, that is to say, the clearer the global architecture of the image, and the stronger the differences between objects in the image (which is more helpful for classification prediction). The smaller the field of view, the stronger the detail features of the spatial features, and the details of the objects in the image are more descriptive. Therefore, by utilizing the spatial features of different fields of view at the moment of the image to be restored, further restoration of the image can be carried out.

Specifically, feature maps of each of the plurality of reference images under a plurality of receptive fields may be extracted, and the feature maps under each of the plurality of receptive fields is transformed based on the optical flow image between the reference image and the image to be restored, to obtain inter-frame semantic features under the plurality of receptive fields. In this way, the spatial features depicted by the reference image in various perceptual domains (i.e. fields of view) can be obtained. That is to say, based on the optical flow image, different spatial features from the reference image to the moment of the image to be restored can be depicted globally and locally. Based on these spatial features, global and local details of the image to be restored can be restored.

In this embodiment, the process of extracting the feature maps of the reference image under the plurality of receptive fields can be as follows: iteratively performing convolution operations on the reference image at a plurality of scales, with each convolution operation being performed on the feature map outputted from the previous convolution operation.

Among them, the convolution kernel selected for each convolution process can be different to obtain the feature maps under the plurality of receptive fields. In some specific embodiments, the feature extraction may be performed on the reference image through a plurality of convolutional layers, each convolutional layer can be regarded as a receptive field. The deeper the convolutional layer, the larger the receptive field, and the stronger the global nature of the image described by the extracted features. The shallower the convolutional layer, the smaller the receptive field, and the stronger the details described by the extracted features in the image.

After extracting the feature maps corresponding to each receptive field, based on the optical flow image between the reference image and the image to be restored, the feature maps of each receptive field can be mapped to the moment of the image to be restored, thereby obtaining estimated inter-frame semantic features. These inter-frame semantic features can reflect the contextual features of the image to be restored and the reference image, and thus restoring the image to be restored globally and locally.

Among them, each reference image includes the feature maps corresponding to the plurality of receptive fields. It should be noted that different reference images can be input into the above multi-layer convolutional layers for feature extraction, thereby obtaining feature maps for the plurality of receptive fields. For example, for reference images N₇ and N₉, they both extract feature maps for four receptive fields.

Correspondingly, when restoring the defects in the image to be restored based on the motion estimation images corresponding to the plurality of reference images to obtain the restored target image, the target image can be obtained by restoring the image to be restored based on the motion estimation images and the inter-frame semantic features corresponding to the plurality of reference images.

In this embodiment, the inter-frame semantic features can assist the motion estimation images in restoring the image to be restored. The motion estimation image is used to restore the bad pixels that appear in the image to be restored based on the position and direction changes of the pixels between frames. The inter-frame semantic features can assist the motion estimation images, to restore the defects such as the bad pixels, the noise, the scratches, etc. that appear in the image to be restored globally and locally.

In some specific embodiments, the image to be restored can be restored based on the motion estimation images corresponding to each reference image. For example, the motion estimation images can be fused with the image to be restored to perform preliminary restoration on the image to be restored. Next, the multiple inter-frame semantic features obtained from all reference images can be fused with the image to be restored after the preliminary restoration, so that the global and local features in the image to be restored can be restored again.

Since each reference image obtains feature maps under different receptive fields, in some embodiments, when transforming the feature maps under each receptive field based on the optical flow image between the reference image and the image to be restored, the feature maps under the receptive field can be transformed in the same size space. That is to say, the optical flow image can be transformed into a size space consistent with the feature maps of each receptive field.

In specific implementation, the optical flow image corresponding to the reference image can be processed at a plurality of scales, to obtain a sub-optical flow image corresponding to each scale; and the feature maps can be mapped under a corresponding receptive field based on the sub-optical flow image corresponding to each of the plurality of scales, to obtain the inter-frame semantic features.

Among them, different scales correspond to different receptive fields.

In some embodiments, there is an optical flow image between each reference image and the image to be restored. In practice, the optical flow image can be processed at multiple scales, the processing can refer to a downsampling processing. Each downsampling scale can be different to process the optical flow image into a size suitable for the feature map of each receptive field.

Correspondingly, for each reference image, the feature maps of each receptive field of the reference image can be mapped based on a sub-optical flow image of the corresponding size, that is, to transform the feature maps into the inter-frame semantic features at the moment of the image to be restored. In some embodiments, for the feature maps of each receptive field, a warp operation can be performed on a sub-optical flow image of a certain size to obtain the corresponding inter-frame semantic features.

After obtaining the inter-frame semantic features of the above embodiments, in some embodiments, the motion estimation image can be first used for preliminary restoration of the image to be restored. After restoration, the inter-frame semantic features can be used to correct the image to be restored after the preliminary restoration.

In specific implementation, feature fusion can be performed on the image to be restored and the motion estimation images corresponding to the plurality of reference images, to restore the defects in the image to be restored and obtain a coarse restored feature map; and feature correction is performed on the coarse restored feature map based on the inter-frame semantic features respectively corresponding to the plurality of reference images, to obtain the target image.

In some embodiments, the process of performing feature fusion on the image to be restored and the motion estimation images respectively corresponding to the plurality of reference images can be as follows: concatenating the image to be restored and the plurality of reference, and performing feature extraction on the concatenated features using the convolutional layers to obtain the coarse restored feature map. Among them, the concatenation can refer to the Concat operation.

Among them, based on the inter-frame semantic features corresponding to the plurality of reference images, when performing the feature correction on the coarse restored feature map, the inter-frame semantic features can be fused with the coarse restored feature map according to the size of the receptive field. In some specific implementations, the plurality of inter-frame semantic features belonging to the same receptive field can be fused with the coarse restored feature map, and then the plurality of inter-frame semantic features belonging to another receptive field are fused with the coarse restored feature map, and so on, until all inter-frame semantic features of all receptive fields are fused. In this way, the inter-frame semantic features of different receptive fields can be fused in stages.

Among them, it may fuse in the order of sizes of the receptive fields from small to large. For example, the plurality of inter-frame semantic features of the same receptive field with small size can be fused with the coarse restored feature map first, and then the plurality of inter-frame semantic features belonging to another receptive field with large size may be fused with the coarse restored feature map. In this way, the coarse restored feature map can be corrected according to the restoration process from details to the whole.

In some embodiments, to improve the correction effect, the feature correction can also be performed on the coarse restored feature map with a corresponding size according to the size of the receptive field during correction. That is to say, the inter-frame semantic features of each receptive field are used to correct the coarse restored feature map under that receptive field.

In specific implementation, the plurality of inter-frame semantic features belonging to the same receptive field can be obtained from the inter-frame semantic features corresponding to the plurality of reference images; and based on the plurality of inter-frame semantic features corresponding to the plurality of receptive fields, the coarse restored feature maps are corrected under the plurality of receptive fields to obtain the target image.

Specifically, since the inter-frame semantic features of each receptive field are used to correct the coarse restored feature map under that receptive field, in some embodiments, the inter-frame semantic features of each receptive field can be used separately to correct the coarse restored feature map under that receptive field. In specific implementation, the feature extraction can be performed again on the coarse restored feature map under the plurality of receptive fields, to obtain sub-feature maps corresponding to each receptive field. Then, the sub-feature maps of each receptive field are fused with all inter-frame semantic features of each reference image under that receptive field, to obtain the corrected image features under that receptive field. Then, the corrected image features under the plurality of receptive fields are fused to obtain the target image.

For example, after performing the feature extraction again on the coarse restored feature map under the plurality of receptive fields, the sub-feature maps of four receptive fields are obtained. Then, the sub-feature maps of each receptive field are fused with the plurality of inter-frame semantic features under that receptive field, to obtain the corrected image features of that receptive field. Since there are the inter-frame semantic features of four receptive fields. Therefore, four types of corrected image features can be obtained, and then the four types of corrected image features are fused to obtain the target image.

In some embodiments, the inter-frame semantic features under the plurality of receptive fields can be utilized to perform multiple iterations of feature fusion on the coarse restored feature map. Each iteration of feature fusion can fuse all inter-frame semantic features under one receptive field with the features obtained from the previous feature fusion. In this way, it may continuously utilize the inter-frame semantic features of different spatial structures in order of sizes of the receptive fields to complete the features of different detail sizes in the coarse restored feature map. Figuratively, it can be understood as the following process:
firstly, utilizing the inter-frame semantic features of the receptive field with a smaller size, to perform feature completion with finer details on the coarse restored feature map, such as completing the pixels of a hand of a person in the image;
next, for the coarse restored feature map after completing the finer details, using the inter-frame semantic features of the receptive field with a larger size to complete larger details, such as completing the contour of the hand; and
and so on, completing the details layer by layer to and obtain the target image.

In specific implementation, the first feature fusion can be iteratively performed multiple times in an order of preset sizes of the receptive fields, until the plurality of inter-frame semantic features of all receptive fields are fused, to obtain a second fusion feature; next, the target image is acquired based on the second fusion feature.

Among them, in the first feature fusion of each time, the feature fusion is performed on the plurality of inter-frame semantic features of the receptive field corresponding to the first feature fusion of a current time and first fusion features outputted after performing the first feature fusion of a previous time.

In this embodiment, iterative fusion can be performed in the order of the sizes of the receptive fields from small to large. Specifically, the coarse restored feature map can be fused with the plurality of inter-frame semantic features of the receptive field with the smallest size, to obtain the first fusion feature, and the plurality of inter-frame semantic features of the receptive field with the smallest size can include the inter-frame semantic features from different reference images.

Next, the first fusion feature can be fused with the plurality of inter-frame semantic features of the receptive field with a second-smallest size, to obtain the fused first fusion feature. Similarly, the plurality of inter-frame semantic features of the receptive field with a second-smallest size can include the inter-frame semantic features from different reference images.

And so on, the fused first sub-fusion feature is fused with the plurality of inter-frame semantic features of the next receptive field, to obtain the fused first sub-fusion feature of a current time. Follow the above steps until the inter-frame semantic features of all receptive fields are fused, and then the fused feature obtained from the last fusion is used as the second fusion feature.

Among them, the image corresponding to the second fusion feature can be used as the target image, or a upsampling operation is performed on the second fusion feature to obtain the corresponding target image.

In some embodiments, after utilizing the inter-frame semantic features of the plurality of receptive fields and correcting the coarse restored feature maps under the plurality of receptive fields, the corrected coarse restored feature maps under each receptive field can also be fused to fuse the corrected results under different receptive fields, thus making the correction more accurate.

In specific implementation, when obtaining the target image based on the second fusion feature, some or all of the first fusion features can be obtained, and each first fusion feature corresponds to one receptive field; and the second feature fusion are iteratively performed to obtain the target image.

Among them, when performing the second feature fusion each time, features outputted after performing the second feature fusion of a previous time are fused with the first fusion features under the receptive field corresponding to the second feature fusion of a current time.

In some embodiments, all first fusion features in multiple first feature fusion processes can be fused with the second fusion feature, or the first fusion feature of the receptive field with a smaller size can be fused with the second fusion feature. For example, assuming J first feature fusions are performed, the first fusion feature outputted from the previous J−2 first feature fusions can be constructed and fused with the second fused feature.

In one example, the specific process can be as follows:
S1: fusing the second fusion feature with the first fusion feature outputted from the first feature fusion of a first time, to obtain the fused second fusion feature;
S2: fusing the fused second fusion feature with the first fusion feature outputted from the first feature fusion of a second time, to obtain the fused second fusion feature of this time;
S3: fusing the fused features obtained from S2 with the first fusion feature outputted from the first feature fusion of a third time, to obtain the fused second fusion feature of this time, thus obtaining the target image.

In this way, the second fusion feature obtained by iteratively performing the first feature fusion multiple times can be fused again with the restoration result obtained from the first feature fusion of each previous time, thereby improving the restoration effect of the image to be restored.

In some embodiments, when using inter-frame semantic features under the plurality of receptive fields to perform detail completion for different receptive fields on the coarse restored feature map, detail completion can be sequentially performed in order of the sizes of the receptive fields from small to large; when integrating multiple detail completion results, fusion can be performed in order of the sizes of the receptive fields from large to small. That is to say, the detail completion results under the high receptive field is integrated firstly, and then the receptive field is gradually reduced, to perform complete detail completion under the receptive field with a smaller size.

Specifically, in the first feature fusion of two adjacent times, a size of the receptive field targeted by the first feature fusion of the previous time is less than a size of the receptive field targeted by the first feature fusion of a next time; and in the second feature fusion of every two times, a size of the receptive field targeted by the second feature fusion of the previous time is greater than a size of the receptive field targeted by the first feature fusion of a next time.

When using the implementation solution of the first method mentioned above, due to using the inter-frame semantic features under the plurality of receptive fields to correct the image to be restored, it may start from the global and local features of the image, the global contour and details of the image to be restored can all be restored, thus improving the restoration effect.

(2) The second method: combining the original reference image, the motion estimation image, and the contextual inter-frame information between the image to be restored and the reference image, to restore the image to be restored.

In some embodiments, it may combine the original reference image to first restore the bad pixels in the image to be restored, and then use the motion estimation images to further restore the bad pixel restored image, or combine the motion estimation images with the inter-frame information (inter-frame semantic features) to further restore the bad pixel restored image.

Among them, based on the plurality of reference images, the bad pixels in the image to be restored can be restored to obtain the further restore the bad pixel restored image. Next, based on the motion estimation images respectively corresponding to the plurality of reference images, the bad pixel restored image is restored to obtain the target image.

Alternatively, based on the motion estimation images and the inter-frame semantic features corresponding to the plurality of reference images, the bad pixel restored image is restored to obtain the target image.

Since the defect areas included in the reference images that have a temporal continuity with the image to be restored cannot be exactly the same as that included in the image to be restored, some complete information about the defect areas in the image to be restored can be obtained from the reference images. Therefore, in this embodiment, the plurality of reference images can be used to restore the bad pixels in the image to be restored.

In practice, it may identify an defect area in the image to be restored, and then locate the target area corresponding to the defect area from the plurality of reference images. The target area and the defect area can actually be the same area for the same object. In this way, the pixel information of each pixel in the defect area can be restored based on the pixel information of each pixel in the target area. For example, the pixel values of each pixel in the target area are fused with the pixel values of each pixel in the defect area to obtain the bad pixel restored image.

Among them, after restoring the bad pixels in the image to be restored, the image restoration problem can be transferred to the artifact restoration of the image, thereby improving the accuracy of image restoration.

In some embodiments, since the previous reference image and the next reference image that are adjacent to the image to be restored include more identical information with the image to be restored, it may restore the area corresponding to the defect-free area in the image to be restored based on the defect-free area in the previous image and the next image that are adjacent to the image to be restored among the plurality of reference images, to obtain the bad pixel restored image.

Specifically, based on the previous reference image and the next reference image, a median filtering operation can be performed on the image to be restored, to obtain the bad pixel restored image.

Among them, the median filtering operation is a non-linear smoothing technique that sets the grayscale value of each pixel as the median value of the grayscale values of all pixels within a neighboring window of that pixel. In specific implementation, the median value can be calculated pixel by pixel for the image to be restored, the previous image, and the next image. Since the pixel values of adjacent frames in the same scene at the same position generally do not differ too much, in the process of calculating the median value, the bad pixel areas that differ greatly from the surrounding grayscale values will be replaced by the pixels in the previous frame image or the next frame image, thereby eliminating the bad pixels in the middle frame image.

In some embodiments, when restoring the bad pixel restored image based on the motion estimation images corresponding to the plurality of reference images, or when restoring the bad pixel restored image based on the motion estimation images and the inter-frame semantic features corresponding to the plurality of reference images, the original reference image can also be introduced to perform further restoration on the bad pixel restored image.

In specific implementation, based on the plurality of reference images and the motion estimation images respectively corresponding to the plurality of reference images, the defects in the image to be restored can be restored to obtain the target image.

In the process of restoring the defects in the image to be restored as described in the first method above, in this second method, since the reference image is added for restoration, the image to be restored, the plurality of reference images, and the motion estimation images respectively corresponding to the plurality of reference images can be fused to obtain a coarse restored feature map. Then, using the inter-frame semantic features under multiple receptive fields, the feature correction is performed on the coarse restored feature map to obtain the target image.

Alternatively, the bad pixel restored image, the plurality of reference images, and the motion estimation images respectively corresponding to the plurality of reference images can be fused to obtain the coarse restored feature map. Then, using the inter-frame semantic features under multiple receptive fields, the feature correction is performed on the coarse restored feature map to obtain the target image.

The technical solution using this implementation method first restores the bad pixels in the image to be restored by using the previous image and the next image that are adjacent to the image to be restored. Then, based on the motion estimation images, the bad pixel restored images are restored to restore the defects such as artifacts and scratches in the image to be restored, thereby improving the restoration effect.

(3) The third method: utilizing a flattened image restoration model to implement the image restoration methods of the first method, the second method, and the preceding embodiments.

Since the present disclosure mainly utilizes the optical flow images between consecutive images to obtain the motion estimation images from the reference image to the moment of the image to be restored, and in some embodiments, the inter-frame semantic features under the plurality of receptive fields from the reference image to the moment of the image to be restored can be obtained. Then, based on the motion estimation images and the inter-frame semantic features, the image to be restored is restored. In this way, even when the magnitude of motion between adjacent frames is large, the position and motion changes of pixels can still be extracted based on the optical flow image, and the image of the next frame can be estimated. This way, the size of the receptive field is no longer limited. Therefore, when using neural network models to complete the above image restoration methods, an optical flow network for extracting optical flow information and a generative network for image fusion can be designed. This generative network can be used to fuse the image to be restored and the motion estimation image, or to fuse the image to be restored, the motion estimation image, and the inter-frame semantic features under the plurality of receptive fields.

As a result, there is no need to deepen the depth of the model or introduce the unnecessary parameter quantities, so that it does not consume a lot of computational resources, thereby improving processing efficiency.

Specifically, referring to FIG. 4, a schematic structural diagram of an image restoration model according to an embodiment of the present disclosure is shown. The image restoration model may include an optical flow network and a generative network. The optical flow network may be used to output the optical flow image between each reference image and the image to be restored, while the generative network is used to restore the image to be restored based on the optical flow image and the motion estimation images corresponding to the reference images.

Below, according to the process of image restoration, each functional module in the image restoration model is introduced separately:

1. For the optical flow network.

In some embodiments, the optical flow network may not be included in the image restoration model and can be applied separately. That is to say, the optical flow network can utilize existing optical flow networks without increasing the parameter quantity of the image restoration model.

Specifically, the plurality of reference images and the image to be restored can be input into the optical flow network, the optical flow network outputs the optical flow images between the image to be restored and the plurality of reference images. Then, based on each reference image and the optical flow image between the reference image and the image to be restored that are outputted by the optical flow network, the reference image is mapped to obtain the motion estimation image.

In some embodiments, the image to be restored and the optical flow images corresponding to the plurality of reference images can be input into the generative network for restoring the image to be restored.

In some embodiments, the optical flow network and the generative network can be located in the image restoration model, and trained together with the image restoration model. Specifically, the image to be restored and the plurality of reference images can be input into the optical flow network of the image restoration model. The optical flow image between the image to be restored and the plurality of reference images can be output through the optical flow network.

Next, the image to be restored and the motion estimation images corresponding to the plurality of reference images are input into the generative network of the image restoration model to restore the defects in the image to be restored and obtain the target image.

As shown in FIG. 4, the image restoration model includes the optical flow network and the generative network. A motion estimation unit is connected between the optical flow network and the generative network. The motion estimation unit is used to, based on each reference image and the optical flow image between the reference image and the image to be restored outputted by the optical flow network, map that reference image, to obtain the motion estimation image.

Referring to FIG. 5, a schematic structural diagram of an optical flow network according to an embodiment is shown. It should be noted that whether used alone or configured into the image restoration model, the optical flow network with this architecture can be adopted. As shown in FIG. 5, “Downsample_n” represents downsampling the input n times using bilinear interpolation, “Upsample_n” represents upsampling the input n times using the bilinear interpolation, and “Conv_i_o_k_s” represents the concatenation operation of the convolutional layer and ReLU activation layer, where i is the number of input channels, o is the number of output channels, k is the size of the convolution kernel, s is the convolution step size, and “Conv_i_o_k_s*n” represents the concatenation of n “Conv_i_o_k_s”. Among them, the input of the optical flow network includes: the reference image and the image to be restored.

As shown in FIG. 5, the optical flow network can include multiple serially connected feature transformation modules and a feature processing module connected after the last feature transformation module. Each feature transformation module, from a shallow layer to a deep layer, sequentially includes a concatenation layer, a downsampling layer, a first convolutional layer, a second convolutional layer, a third convolutional layer, an upsampling layer, and a warp layer. The feature processing module includes a concatenation layer, a fourth convolutional layer, a fifth convolutional layer, a sixth convolutional layer, and a feature addition layer that are sequentially connected. Among them, the output of the feature addition layer is the optical flow image.

Among them, the input end of the concatenation layer of each feature transformation module is used to input the image to be restored and the target image, the target image can be the reference image or the output of the warp layer of the previous feature transformation module. Among them, for the feature transformation module of the first layer, the input target image is the reference image; and for the other feature transformation modules, the input target image is the output of the warp layer of the previous feature transformation module.

Among them, for the warp layer of each feature transformation module, the warp layer is used to perform the warp operation on the reference image based on the output of the upsampling layer, and the result obtained is output to the next feature transformation module. That is to say, the reference image needs to be input into the warp layer of each feature transformation module.

Based on the optical flow network shown in FIG. 5, where framet is the image to be restored, and frameti is the reference image, the process of obtaining the optical flow image can be described as follows:

Firstly, the optical flow network first concatenates the input reference image and the image to be restored, performs 8x downsampling, and after sampling, performs operations on 8 convolutional layers (in this example, there are a total of 8 convolutional layers of the first convolutional layers, the second convolutional layers, and the third convolutional layers) to obtain the optical flow images of adjacent two frames of images at a resolution that is ⅛ of the original resolution. After upsampling this optical flow image by 8 times, the preliminary estimated image is obtained by performing the warp operation on the optical flow image and frameₜ₋₁.

Secondly, it continues performing the concat processing on this image and the frameₜ, downsamples it by 4 times, performs the operations on the 8 convolutional layers to obtain the optical flow image at a resolution that is ¼ of the original resolution, upsamples this optical flow image by 4 times and add it pixel by pixel with the optical flow image obtained at the resolution that is ⅛ of the original resolution, and performs the warp operation on the sum of their additions with the frameₜ₋₁ to obtain a further estimated image.

Thirdly, after performing the concat processing on that estimated image with the framet, it downsamples twice and performs the operations on the 8 consecutive convolutional layers to obtain the optical flow image at a resolution that is ½ of the original resolution, upsamples twice the optical flow image and adds it pixel by pixel with the optical flow images obtained in the previous two steps, and continues to perform the warp operation on the sum obtained with the frameₜ₋₁ to obtain the estimated image.

Fourth, finally performing the concat processing on the estimated image from the previous step with the frameₜ, and then directly calculating it with 8 convolutional layers in sequence to obtain the optical flow image at the original resolution, and adding this optical flow image pixel by pixel with the optical flow image obtained from the previous three steps, to obtain the final optical flow image flow_{t-1→t}.

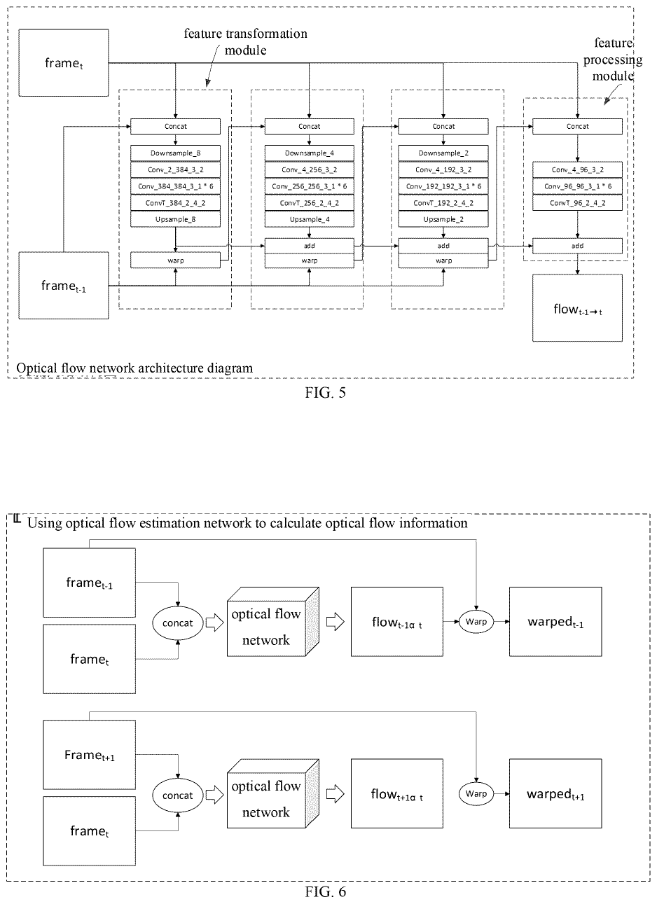

In some embodiments, the motion estimation can be performed based on the optical flow image and the reference image outputted by the optical flow network to obtain the motion estimation image. Referring to FIG. 6, a schematic diagram of the process of obtaining the motion estimation image is shown. As shown in FIG. 6, the image to be restored frame, and the reference image frameₜ₋₁ can be input into the optical flow network to obtain the optical flow image flow_{t-1→t}. Then, based on the optical flow image flow_{t-1→t}, the Warp operation is performed on the reference image frameₜ₋₁ to obtain the motion estimation image warpedₜ₋₁ from the reference image to the moment of the image to be restored frameₜ.

As shown in FIG. 6, similarly, the motion estimation image warpedₜ₊₁ can be obtained from frameₜ₊₁ to the moment of the image to be restored frameₜ.

2. For the semantic network.

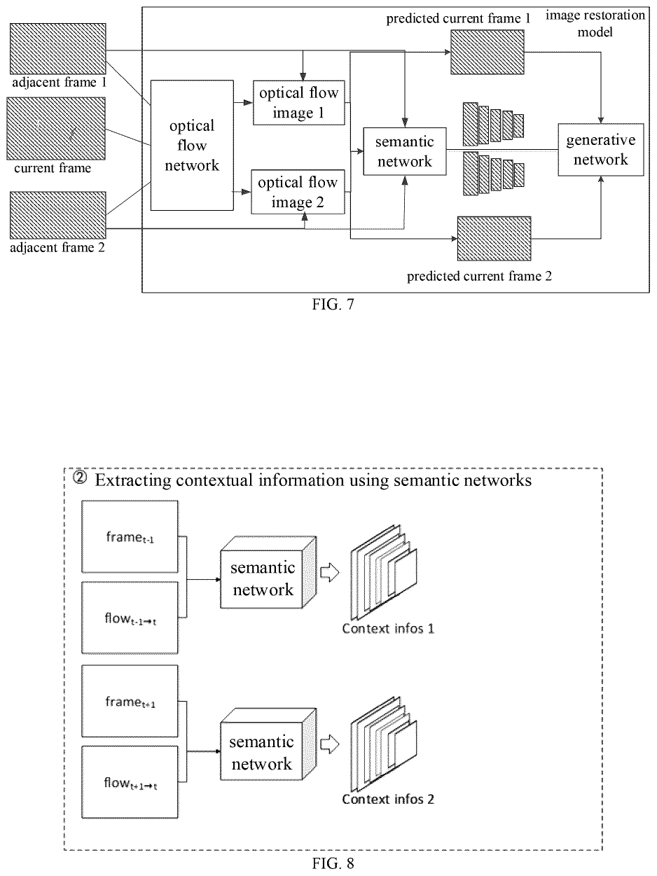

Referring to FIG. 7, a schematic structural diagram of an image restoration model in another embodiment of the present disclosure is shown. As shown in FIG. 7, the image restoration model includes the optical flow network, a semantic network, and the generative network. The output end of the optical flow network is connected to the input end of the semantic network, and the output end of the semantic network is connected to the input end of the generative network. The output end of the optical flow network can also be connected to the motion estimation unit, the motion estimation unit can perform the motion estimation on the reference image based on the optical flow image corresponding to the reference image, to obtain the motion estimation image.

In this embodiment, both the motion estimation image and the inter-frame semantic features outputted by the semantic network are input to the generative network.

In specific implementation, referring to FIG. 8, a schematic diagram of the input and output of the semantic network is shown. As shown in FIG. 8, the optical flow image and the reference image can be input into the semantic network of the image restoration model, and the semantic features of each reference image can be extracted through the semantic network. The optical flow image performs inter-frame transformation on the semantic features of the reference image to obtain the inter-frame semantic features.

Correspondingly, the image to be restored and the motion estimation images and the inter-frame semantic features corresponding to the plurality of reference images can be input into the generative network of the image restoration model to restore the defects of the image to be restored and obtain the target image.

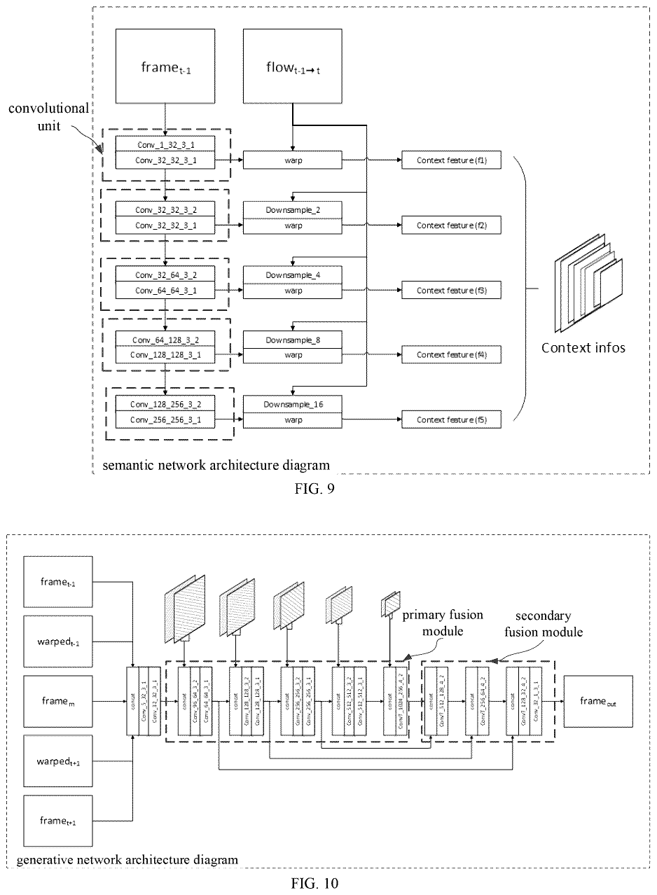

In some embodiments, referring to FIG. 9, a schematic structural diagram of a semantic network is shown. As shown in FIG. 9, the semantic network includes a convolution module and a downsampling module. Among them, the convolution module includes a plurality of convolution units that are sequentially connected in series, and the downsampling module includes a plurality of downsampling units;
each of the plurality of convolution units is configured for performing feature extraction on features outputted by a previous convolution unit, wherein each of the plurality of convolution units is configured for performing the feature extraction on the reference image and inputting extracted feature maps into a corresponding downsampling unit; wherein different convolution units connect to different downsampling units;
each of the plurality of downsampling units is configured for performing an downsampling operation on the optical flow image at a corresponding scale to obtain a sub-optical flow image based on the downsampling operation, and transforming the feature maps outputted by the corresponding convolution unit to obtain the inter-frame semantic feature.

Among them, as shown in FIG. 9, each convolution unit can include two convolution layers, and the setting of the convolution kernels for each convolution layer can refer to FIG. 9. Among them, each downsampling unit includes a downsampling layer and a warp layer, and the input of the downsampling layer is an optical flow image. The setting of sampling multiples for different downsampling layers can refer to FIG. 9. Among them, the warp layer is connected after the downsampling layer and is connected to the output end of the last convolutional layer of the corresponding convolution unit, and the warp layer is used to perform the warp operation on the inter-frame semantic features based on the sub-optical flow image obtained by the downsampling operation, to obtain the inter-frame semantic features.

In this embodiment, the process of obtaining the inter-frame semantic features is as follows:
firstly, for the reference image frameₜ₋₁, the first layer of semantic features is obtained through the two convolutional layers of the first convolutional unit, the warp operation is performed on this first layer of semantic features and the optical flow image flow_{t-1→t} to obtain semantic information f1;
secondly, the first layer of semantic features (not subjected to the warp operation) is sequentially input into the two convolutional layers of the second convolutional unit, namely the third convolutional layer and the fourth convolutional layer, to obtain the second layer of semantic features, the width and height of this second layer of semantic features are half of the original input, thus expanding the receptive field; and flow_{t-1→t} is downsampled twice using the bilinear interpolation method and then subjected to the warp operation with the feature matrix, to obtain semantic information f2;
thirdly, the second layer of semantic features is input into the two convolutional layers of the third convolutional unit, namely the fifth convolutional layer and the sixth convolutional layer, to obtain a third layer of semantic features with a width and height of ¼ of the original input, thus further expanding the receptive field; and flow_{t-1→t} is downsampled by 4 times, and then subjected to the warp operation with the feature matrix, to obtain semantic information f3;
fourth, the third layer of semantic features is input into the two convolutional layers of the fourth convolutional unit, namely the seventh convolutional layer and the eighth convolutional layer, to obtain the fourth layer of the semantic features with a width of ⅛ of the original input, thus further expanding the receptive field; and flow_{t-1→t} is downsampled by 8 times, and then subjected to the warp operation with the fourth layer of semantic features, to obtain semantic information f4;
fifth, the fourth layer of semantic features is input into the two convolutional layers of the fifth convolutional unit, namely the ninth convolutional layer and the tenth convolutional layer, to obtain the fifth layer of semantic features with a width and height of 1/16 of the original input, thus expanding the receptive field again; and flow_{t-1→t} is downsampled by 16 times, and then subjected to the warp operation with the fifth layer of semantic features, to obtain semantic information f5;
sixth, f1, f2, f3, f4, and f5 are taken as frameₜ₋₁, the semantic information sequence Context infos_1 of the estimated image obtained by mapping the flow_{t-1→t}, and
seventh, steps a to f are repeated on the adjacent frame image frameₜ₊₁ and the optical flow image flow_{t+1→t} to obtain the semantic information sequence Context_infos_2.

Among them, f1, f2, f3, f4, and f5 are the inter-frame semantic features of the present disclosure, where the first layer of semantic features to the fifth layer of semantic features can all be the feature matrices.

Certainly, FIG. 9 is only an illustrative example. In practice, there can also be more layers of convolution units or fewer layers of convolution units. Specifically, it can be determined based on the magnitude of the motion or the size of the image, and is not particularly limited here.

3. For the generative network.

The generative network can be used to restore the image to be restored based on the motion estimation image, or to restore the image to be restored based on the motion estimation images and the inter-frame semantic features of the reference images, or to restore the bad pixel restored image based on the reference images, the motion estimation images, and the inter-frame semantic features of the reference images. In this way, the above images can be input into the generative network.

Specifically, in the case of restoring the bad pixel restored image based on the reference images, the motion estimation images, and the inter-frame semantic features of the reference images, or in the case of restoring the image to be restored based on the motion estimation images and the inter-frame semantic features of the reference images, the generative network may include:
a feature concatenation module, as well as a primary fusion module and a secondary fusion module that are sequentially connected in series.

Among them, the functions of each module are as follows:
the feature concatenation module is configured for performing feature fusion on the image to be restored and the motion estimation images respectively corresponding to the plurality of reference images, to obtain a coarse restored feature map;
the primary fusion module includes a plurality of first fusion units that are sequentially connected in series; each of the plurality of first fusion units is configured for performing the feature fusion on a plurality of inter-frame semantic feature under one receptive field and a first fusion feature outputted by a previous first fusion unit; wherein different first fusion units correspond to the plurality of inter-frame semantic features under different receptive fields; and
the secondary fusion module is configured for outputting the target image based on a second fusion feature.

Among them, the secondary fusion module processes the second fusion feature to obtain the target image, the process of obtaining the target image can refer to the process described in the above embodiments and will not be repeated here.

Specifically, the input end of the feature concatenation module can be connected to the input end of the motion estimation unit. The reference image, the image to be restored, and the motion estimation image can all be input to the input end of the concatenation module. The output end of the concatenation module is connected to the firs one of the first fusion units in the primary fusion module. In this embodiment, each first fusion unit can be correspondingly connected to the output end of one downsampling unit. Alternatively, the output ends of multiple downsampling units can be connected to the input end of the first one of the first fusion units in the primary fusion module. The specific fusion process can refer to the above embodiments.

In some embodiments, since when multiple feature extractions are performed on the second fusion feature to output the target image, the results of restoring the coarse restored feature maps using multiple receptive fields can be fused. Therefore, the secondary fusion module may include multiple second fusion units that are sequentially connected in series, where the input end of one second fusion unit is connected to the output ends of the previous second fusion unit and one first fusion unit.

Among them, each second fusion unit is used to fuse the features outputted by the previous second fusion unit with the first fusion feature outputted by the corresponding first fusion unit, and input them to the next second fusion unit. Among them, the target image can be output through the last second fusion unit.

Specifically, the input ends of different first fusion units can be connected to the output ends of different downsampling units in the semantic network, thereby inputting the inter-frame semantic features outputted by different downsampling units in the semantic network into the first fusion unit. Among them, different second fusion units can be connected to the output ends of corresponding first fusion units, thereby fusing the correction results under the corresponding receptive field.

Referring to FIG. 10, a schematic structural diagram of a generative network in some embodiments is shown. As shown in FIG. 10, the images input into the generative network include the reference image frameₜ₋₁, the reference image frameₜ₊₁, the image to be restored frameₘ, the motion estimation image warpedₜ₋₁ of the reference image frameₜ₋₁, and the motion estimation image warpedₜ₊₁ of the reference image frameₜ₊₁. Among them, multiple inter-frame semantic features are input to a specific fusion module of the generative network.

As shown in FIG. 10, in the network architecture of the generative network, “ConvT_i_ok_s” represents the concatenation of 2D transposed convolution and ReLU activation layers, i represents the number of the input channels, o represents the number of the output channels, k represents the size of the convolution kernel, s represents the convolution step size. The shaded rectangles connected above the network in the figure refer to the inter-frame semantic features extracted under different receptive fields. From left to right (the sizes of the receptive fields from small to large), they are f1, f2, f3, f4, and f5 in sequence.

The process of generating the target image through the generative network is as follows:
firstly, median filtering is performed on frameₜ₋₁, frameₜ, and frameₜ₊₁ pixel by pixel to obtain the filtered image frameₘ, and this step involves filling in the defective areas with the content of adjacent frames through the median filtering;
secondly, concat processing is performed on frameₜ₋₁, warpedₜ₋₁, frameₘ, warpedₜ₊₁, and frameₜ₊₁ in order, and then they are input into the first convolutional layer and the second convolutional layer of the generative network for feature extraction, to obtain the feature matrix F1;
thirdly, the inter-frame semantic features f1 are extracted from the Context_infos_1 and Context_infos_2 outputted by the semantic network shown in FIG. 9, and inputted into the first one of the first fusion units, that is, after being subjected to the concat processing with F1, they are inputted into the third convolutional layer and the fourth convolutional layer of the generative network, to obtain the feature matrix F2;
fourthly, the inter-frame semantic features f2 are extracted from the Context_infos_1 and Context_infos_2 outputted by the semantic network shown in FIG. 9, and inputted into the second one of the first fusion units, that is, after being subjected to the concat processing with F2, they are inputted into the fifth convolutional layer and the sixth convolutional layer of the generative network, to obtain the feature matrix F3;
fifth, the inter-frame semantic features f3 are extracted from the Context_infos_1 and Context_infos_2 outputted by the semantic network shown in FIG. 9, and inputted into the third one of the first fusion units, that is, after being subjected to the concat processing with F3, they are inputted into the seventh convolutional layer and the eighth convolutional layer of the generative network, to obtain the feature matrix F4;
sixth, the inter-frame semantic features f4 are extracted from the Context_infos_1 and Context_infos_2 outputted by the semantic network shown in FIG. 9, and inputted into the fourth one of the first fusion units, that is, after being subjected to the concat processing with F4, they are inputted into the ninth convolutional layer and the tenth convolutional layer of the generative network, to obtain the feature matrix F5;
seventh, the inter-frame semantic features f5 are extracted from the Context_infos_1 and Context_infos_2 outputted by the semantic network shown in FIG. 9, and inputted into the fifth one of the first fusion units, that is, after being subjected to the concat processing with F5, they are inputted into the 11th convolutional layer of the generative network (this layer is transposed convolution), to obtain the feature matrix F6;
eighth, the concat processing are performed on F6 and F4, and they are inputted into the first one of the second fusion units of the secondary fusion module, that is, the 12th convolutional layer of the generative network (this layer is transposed convolution), to obtain the feature matrix F7;
ninth, the concat processing are performed on F7 and F3, and they are inputted into the second one of the second fusion units of the secondary fusion module, that is, the 13th convolutional layer of the generative network (this layer is transposed convolution), to obtain the feature matrix F8;
tenth, the concat processing are performed on F8 and F2, and they are inputted into the third one of the second fusion units of the secondary fusion module, that is, the 14th convolutional layer of the generative network (this layer is transposed convolution), to obtain the feature matrix F9; and
eleventh, after F9 passes through the last convolutional layer of the generative network (this convolutional layer does not have the ReLU activation layer), the final restoration result is obtained, which is the target image.

Among them, the feature matrices F1-F9 are not shown in FIG. 10.

In some embodiments, the process of obtaining the image restoration model shown in FIG. 7 by training can be as follows:

Firstly, training samples are prepared, where the training samples includes multiple sample groups, each sample group includes multiple consecutive frames of video image samples. The multiple frames of video image samples include defect image samples to be restored, as well as restored image samples corresponding to the defect image samples. Among them, the defect image samples can be image samples that have undergone defect processing on the restored image samples. For example, adding defects such as bad pixels and scratches to some areas of a complete and defect-free restored image sample, to obtain a defect image sample.

Among them, the above sample group can be used to train the network architecture shown in FIG. 7. After inputting the sample group into the network architecture, the output restored image after restoring the defect image sample can be obtained. Then, based on the difference between the restored image and the restored image sample, the hyperparameters in the network architecture can be continuously adjusted. In the case where the difference between the restored image and the restored image sample is less than the preset difference, the training can be ended to obtain the image restoration model. Certainly, the image restoration model can also be obtained by ending the training process after reaching the preset number of training iterations.

Among them, the optical flow network in the image restoration model can also be trained separately. There are no restrictions on the selection of the optical flow network, which can be any currently open source optical flow network, such as flownet, flownet2; and which can also be a traditional optical flow algorithm (not deep learning), such as TV-L1 flow, which only needs to use the optical flow algorithm to obtain the optical flow image. Among them, the process of training the optical flow networks can refer to related art, and will not be repeated here.

After separately training and obtaining the optical flow network, the parameters of the optical flow network can be transferred to the optical flow network of the network architecture shown in FIG. 7. Then, the parameters of the network architecture shown in FIG. 7 can be fine-tuned using the above sample groups, to obtain the image restoration model.

Below, combined with the image restoration model shown in FIG. 7, an image restoration method in an embodiment of the present disclosure will be introduced exemplarily:
firstly, the sample groups are prepared to train the network architecture shown in FIG. 7, to obtain the image restoration model. The sample groups include multiple consecutive frames of video image samples, the multiple consecutive frames of video image samples include the defect image samples to be restored, as well as restored image samples corresponding to the defect image samples. Among them, the multiple frames of video image samples also include the previous frame image sample and the next frame image sample that are adjacent to the defect image sample. Among them, the training process is as described in the above embodiments.

Next, the obtained image restoration model is applied to the inference stage for restoring the images in the video data, which includes the following steps:
S100, obtaining images to be restored with defects such as the bad pixels, the scratches, and the artifacts in the video data; for each image to be restored, obtaining the previous frame reference image frameₜ₋₁ and the next frame reference image frame that are adjacent to the image to be restored frameₜ;
S200, based on the previous frame reference image framet-a and the next frame reference image frameₜ₊₁, performing the median filtering on the image to be restored framet to restore the bad pixels in the image to be restored, and obtain the bad pixel restored image frameₘ;
S300, inputting the previous frame reference image frameₜ₋₁, the next frame reference image frameₜ₊₁, and the image to be restored framer into the optical flow network of the image restoration model, that is, the optical flow network shown in FIG. 5, and inputting the previous frame reference image frameₜ₋₁, the next frame reference image frameₜ₊₁ into the semantic network;
and, inputting the bad pixel restored image frameₘ into the generative network, to obtain the optical flow image frame_{t-1→t} from the previous frame reference image outputted by the optical flow network to the image to be restored, as well as the optical flow image frame_{t+1→t} from the next frame reference image to the image to be restored;
S400, inputting the two optical flow images outputted by the optical flow network into the motion estimation unit and the semantic network;
S500, by the motion estimation unit in the image restoration model, performing the warp operation on the previous frame reference image frameₜ₋₁ based on the optical flow image frame_{t-1→t}, obtaining the motion estimation image warpedₜ₋₁ corresponding to the previous frame reference image frameₜ₋₁, similarly, obtaining the motion estimation image warpedₜ₊₁ corresponding to the next frame reference image frameₜ₊₁;
S600, by the semantic network, performing the feature extraction on the previous frame reference image frameₜ₋₁ and the next frame reference image frameₜ₊₁, respectively, specifically, the semantic network in FIG. 10 is used for feature extraction to obtain the inter-frame semantic features of five receptive fields, to obtain the sequence Context_infos_1 (f1, f2, f3, f4, and f5) corresponding to the previous frame reference image frameₜ₋₁ and the sequence Context_infos_2 (f1, f2, f3, f4, and f5) corresponding to the next frame reference image frameₜ₊₁.

S700, inputting the sequence Context_infos_1 (f1, f2, f3, 14, and f5) corresponding to the previous frame reference image frameₜ₋₁, the sequence Context_infos_2 (f1, f2, f3, f4, and f5) corresponding to the next frame reference image frameₜ₊₁, the motion estimation image warpedₜ₋₁, the motion estimation image warpedₜ₊₁, the previous frame reference image frameₜ₋₁, and the next frame reference image frameₜ₊₁ into the generative network.

Among them, when inputting the previous frame reference image frameₜ₋₁, the next frame reference image frameₜ₊₁, the motion estimation image warpedₜ₋₁, the motion estimation image warpedₜ₊₁, and the bad pixel restored image frameₘ into the generative network, the concat layer in the generative network needs to concatenate these five frames in the order shown in FIG. 12. That is to say, the motion estimation image warpedₜ₋₁ and the motion estimation image warpedₜ₊₁ are connected to both ends of the bad pixel restored image frameₘ, the previous frame reference image frameₜ₋₁ is connected to one end of the motion estimation image warpedₜ₋₁, and the next frame reference image frameₜ₊₁ is connected to one end of the motion estimation image warpedₜ₊₁. In this way, the motion estimation image moves closer to the bad pixel image to improve the quality of the restoration.

Among them, f1 in the sequence Context_infos_1 and f1 in the sequence Context_infos_2 are input into the first one of the first fusion units of the generative network, two f2 are input to the second one of the first fusion units, two f3 are input to the third one of the first fusion units, two f4 are input to the fourth one of the first fusion units, and two f5 are input to the fifth one of the first fusion units.

The generative network obtains the target image after the bad pixel restored image framem is restored based on the above images.

Among them, after completing the restoration of the image to be restored, the image to be restored in the video data can be replaced with the target image obtained by the restoration, thereby completing the restoration of the entire video data.

Using the image restoration method of the above embodiments has the following advantages:
firstly, by using the optical flow networks instead of 3D convolution to learn the optical flow information between adjacent frames, and based on the optical flow image between the reference image and the image to be restored, the motion estimation image can be predicted. In this way, the content of the current frame (image to be restored) can be predicted through adjacent frames (reference image) without the bad pixels, the bad lines, or the scratches, so that the predicted current frame without the bad pixels, the bad lines, or the scratches can be used to restore the current frame to be restored, thereby improving the restoration effect.

Secondly, since the optical flow images can accurately reflect the magnitude of motion between adjacent frames, that is to say, when the magnitude of motion between adjacent frames is large, it is not limited by the size of the receptive field. Therefore, there is no need to deepen the depth of the model or introduce the unnecessary parameter quantities, so that the acquisition processes of the optical flow image and the motion estimation image do not consume a lot of computational resources, thereby improving processing efficiency.

Thirdly, by using the semantic networks, the inter-frame semantic features under various receptive fields during the process from adjacent frames to the current frame are extracted based on the optical flow images. Therefore, the global and local features during the process from adjacent frames to the current frame can be obtained, and the inter-frame motion information at different observation scales can be further extracted. When using these inter-frame semantic features to correct the image to be restored, they can be used as correction compensation for the motion estimation images, further optimizing the restoration effect.

Fourth, the generative network uses the current frame (the motion estimation image) predicted from the previous and next frames, to further fuse the semantic features, and restore the bad pixel restored image. As the bad pixel restored image is the image after restoring the bad pixels in the image to be restored using adjacent frames, when combining the motion estimation image and the inter-frame semantic features to further restoring the bad pixel restored image, the quality of the restored target image is further improved.

Fifth, by fully utilizing the optical flow information from adjacent frames (reference images) to the current frame (image to be restored) in the motion estimation and extraction of the inter-frame semantic features, the present disclosure does not need to design the image restoration model with deep network layers. This greatly saves model parameters and reduces computational load. In this way, it allows for the flattened image restoration model proposed in some embodiments of the present disclosure, which includes three networks: the optical flow network, the semantic network, and the generative network. The depth of these networks is not deep, so the overall image restoration model is relatively shallow, thereby improving the efficiency of restoring the frames in the video data in the present disclosure.

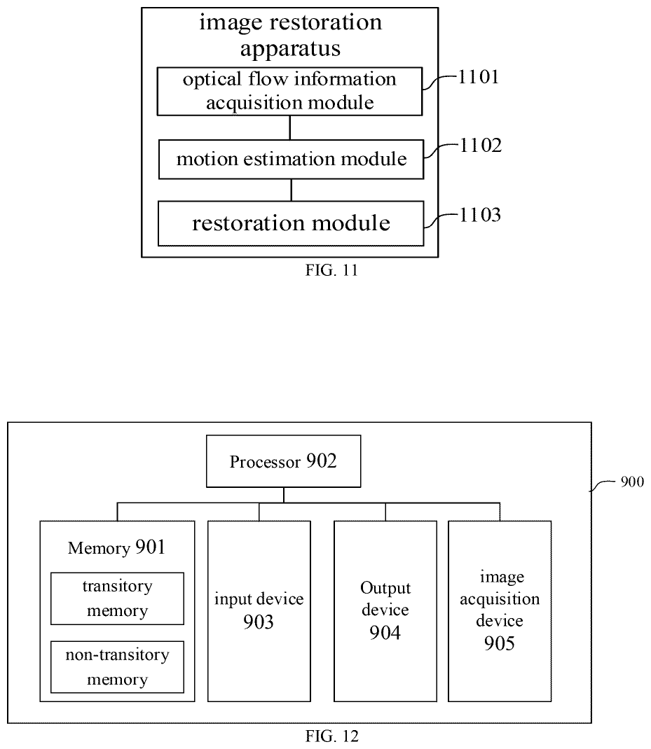

The second aspect of the embodiments also provides an image restoration apparatus. Referring to FIG. 11, a specific structural schematic diagram of the image restoration apparatus is shown, as shown in FIG. 11, which can include the following modules:
an optical flow information acquisition module 1101 configured for, for a plurality of consecutive frames of images of a target video, acquiring an optical flow image between an image to be restored and each of a plurality of reference images; wherein the plurality of reference images include at least a previous frame image and a next frame image that are adjacent to the image to be restored;
a motion estimation module 1102 configured for, based on the optical flow image between each of the plurality of reference images and the image to be restored, performing motion estimation from the reference image to a moment of the image to be restored, to obtain a motion estimation image; and
a restoration module 1103, configured for restoring defects of the image to be restored based on motion estimation images respectively corresponding to the plurality of reference images, to obtain a restored target image; wherein the defects include at least a defect of a bad pixel type.

Optionally, the apparatus further includes:
an inter-frame semantic feature extraction module, configured for extracting feature maps of each of the plurality of reference images under a plurality of receptive fields, and transforming the feature maps under each of the plurality of receptive fields based on the optical flow image between the reference image and the image to be restored, to obtain inter-frame semantic features under the plurality of receptive fields;
wherein the restoration module 1103 is specifically configured for restoring the image to be restored based on the motion estimation images and the inter-frame semantic features respectively corresponding to the plurality of reference images, to obtain the target image.

Optionally, the restoration module 1103 includes:
a first restoration unit, configured for performing feature fusion on the image to be restored and the motion estimation images respectively corresponding to the plurality of reference images, to restore the defects of the image to be restored and obtain a coarse restored feature map; and
a second restoration unit, configured for performing feature correction on the coarse restored feature map based on the inter-frame semantic features respectively corresponding to the plurality of reference images, to obtain the target image.

Optionally, the inter-frame semantic feature extraction module includes:
a first extraction unit, configured for processing the optical flow image corresponding to the reference image at a plurality of scales, to obtain a sub-optical flow image corresponding to each of the plurality of scales; wherein different scales correspond to different receptive fields; and
a second extraction unit, configured for mapping the feature maps under a corresponding receptive field based on the sub-optical flow image corresponding to each of the plurality of scales, to obtain the inter-frame semantic features.

Optionally, the second restoration unit includes:
a combination subunit, configured for acquiring a plurality of inter-frame semantic features belonging to the same receptive field from the inter-frame semantic features respectively corresponding to the plurality of reference images; and
a correction subunit, configured for correcting the coarse restored feature map under the plurality of receptive fields based on a plurality of inter-frame semantic features respectively corresponding to the plurality of receptive fields, to obtain the target image.

Optionally, the second restoration unit includes:
a primary fusion subunit, configured for iteratively performing first feature fusion multiple times in an order of preset sizes of the receptive fields, until the plurality of inter-frame semantic features of all receptive fields are fused, to obtain a second fusion feature; and
a secondary fusion subunit, configured for acquiring the target image based on the second fusion feature;
wherein in the first feature fusion of each time, performing feature fusion on the plurality of inter-frame semantic features of the receptive field corresponding to the first feature fusion of a current time and first fusion features outputted after performing the first feature fusion of a previous time.

Optionally, the secondary fusion subunit is specifically configured for:
acquiring a part or all of the first fusion features, each of the first fusion features corresponding to one receptive field; and
iteratively performing second feature fusion, to obtain the target image; wherein when performing the second feature fusion each time, fusing features outputted after performing the second feature fusion of a previous time and the first fusion features under the receptive field corresponding to the second feature fusion of a current time.

Optionally, in the first feature fusion of two adjacent times, a size of the receptive field targeted by the first feature fusion of the previous time is less than a size of the receptive field targeted by the first feature fusion of a next time; and
in the second feature fusion of every two times, a size of the receptive field targeted by the second feature fusion of the previous time is greater than a size of the receptive field targeted by the first feature fusion of a next time.

Optionally, the optical flow information acquisition module 1101 is specifically configured for inputting the plurality of reference images and the image to be restored into an optical flow network, and outputting the optical flow image between the image to be restored and each of the plurality of reference images by the optical flow network; and
the motion estimation module 1102 is specifically configured for, based on each of the plurality of reference images and the optical flow image between the reference image and the image to be restored outputted by the optical flow network, mapping the reference image, to obtain the motion estimation image.

Optionally, the apparatus further includes:
a bad pixel restoration module, configured for restoring bad pixels in the image to be restored based on the plurality of reference images, to obtain a bad pixel restored image;
wherein the restoration module 1103 is specifically configured for restoring the bad pixel restored image based on the motion estimation images respectively corresponding to the plurality of reference images, to obtain the target image.

Optionally, the bad pixel restoration module is specifically configured for, based on defect-free areas in the previous image and the next image that are adjacent to the image to be restored among the plurality of images, restoring an area corresponding to the defect-free areas in the image to be restored, to obtain the bad pixel restored image.

Optionally, the restoration module 1103 is specifically configured for restoring the defects of the image to be restored based on the plurality of reference images and the motion estimation images respectively corresponding to the plurality of reference images, to obtain the target image.

Optionally, the optical flow information acquisition module 1101 is configured for inputting the image to be restored and the plurality of reference images into an optical flow network of an image restoration model, and outputting the optical flow image between the image to be restored and each of the plurality of reference images by the optical flow network;
wherein the restoration module 1103 is specifically configured for inputting the image to be restored and the motion estimation images respectively corresponding to the plurality of reference images into a generative network of the image restoration model, to restore the defects of the image to be restored, to obtain the target image.

Optionally, the inter-frame semantic feature extraction module is specifically configured for:
inputting the optical flow image and the reference images into a semantic network of an image restoration model, extracting the semantic features of each reference image by the semantic network, and performing inter-frame transformation on the semantic features of the reference image based on the optical flow image, to obtain the inter-frame semantic features;
wherein the restoration module 1103 is specifically configured for inputting the image to be restored, as well as the motion estimation images and the inter-frame semantic features respectively corresponding to the plurality of reference images into a generative network of the image restoration model, to restore the defects of the image to be restored, to obtain the target image.

Optionally, the generative network includes a feature concatenation module, as well as a primary fusion module and a secondary fusion module that are sequentially connected in series after the feature concatenation module; wherein the primary fusion module includes a plurality of first fusion units that are connected in series;
the feature concatenation module is configured for performing feature fusion on the image to be restored and the motion estimation images respectively corresponding to the plurality of reference images, to obtain a coarse restored feature map;
each of the plurality of first fusion units is configured for performing the feature fusion on a plurality of inter-frame semantic feature under one receptive field and a first fusion feature outputted by a previous first fusion unit; wherein different first fusion units correspond to the plurality of inter-frame semantic features under different receptive fields; and
the secondary fusion module is configured for outputting the target image based on a second fusion feature.

Optionally, the secondary fusion module includes a plurality of second fusion units that are sequentially connected in series, wherein an input end of one second fusion unit is connected to output ends of a previous second fusion unit and one first fusion unit;
each of the plurality of second fusion units is configured for fusing features outputted by the previous second fusion unit and the first fusion feature outputted by the corresponding first fusion unit, and inputting into a next second fusion unit; and
the last one of the plurality of second fusion units is configured for outputting the target image.

Optionally, the semantic network includes: a convolution module and a downsampling module; wherein the convolution module includes a plurality of convolution units that are sequentially connected in series, and the downsampling module includes a plurality of downsampling units; wherein
each of the plurality of convolution units is configured for performing feature extraction on features outputted by a previous convolution unit, wherein each of the plurality of convolution units is configured for performing the feature extraction on the reference image and inputting extracted feature maps into a corresponding downsampling unit; wherein different convolution units connect to different downsampling units, and different convolution units correspond to different receptive fields;
each of the plurality of downsampling units is configured for performing an downsampling operation on the optical flow image at a corresponding scale to obtain a sub-optical flow image based on the downsampling operation, and transforming the feature maps outputted by the corresponding convolution unit to obtain the inter-frame semantic feature.

Referring to FIG. 12, a structural block diagram of an electronic device 900 according to an embodiment of the present disclosure is shown. As shown in FIG. 12, the embodiment of the present disclosure provides an electronic device 900 that can be used to perform the image restoration method. The electronic device 900 may include a memory 901, a processor 902, and a computer program stored in the memory and executable on the processor. The processor 902 is configured to perform the image restoration method.

As shown in FIG. 12, in one embodiment, the electronic device 900 may fully include an input device 903, an output device 904, and an image acquisition device 905. When performing the image restoration method of the embodiment of the present disclosure, the image acquisition device 905 may acquire a first image and a second image, and then the input device 903 may obtain the first image and the second image acquired by the image acquisition device 905. The first image and the second image may be processed by the processor 902 to perform image processing based on the first image and the second image. The output device 904 may output the target disparity image obtained after processing the first image and the second image.

Certainly, in one embodiment, the memory 901 may include transitory memory and non-transitory memory, where the transitory memory can be understood as random access memory used to store and preserve data. The non-transitory memory refers to computer memory that stores data that does not disappear when the current is turned off. Certainly, the computer program for the image restoration method of the present disclosure can be stored in both transitory and non-transitory memory, or in either of them.

The embodiment of the present disclosure also provides a computer-readable storage medium, which stores a computer program that enables a processor to execute the image restoration method as described in the embodiment of the present disclosure.

Finally, it should be noted that in this specification, relational terms such as first and second are only used to distinguish one entity or operation from another, and do not necessarily require or imply any actual relationship or order between these entities or operations. Moreover, the terms “including/comprising”, “containing”, or any other variation thereof are intended to encompass non-exclusive inclusion, such that a process, method, good, or equipment that includes a series of elements includes not only those elements, but also other elements not explicitly listed, or elements inherent to such process, method, good, or equipment. Without further limitations, the element defined by the statement “including one . . . ” does not exclude the existence of other identical elements in the process, method, product, or device that includes the element in question.

The above provides a detailed introduction to the image restoration method and apparatus, a device, and a medium provided in the present disclosure. Specific examples are applied in this specification to explain the principles and implementation methods of the present disclosure. The above embodiments are only used to help understand the method and core idea of the present disclosure. Meanwhile, for persons skilled in the art, there may be changes in the specific implementation methods and application scope based on the ideas of the present disclosure. In summary, the content of this specification should not be understood as limiting the present disclosure.

After considering the specification and practicing the invention disclosed herein, persons skilled in the art will easily come up with other implementation solutions of the present disclosure. The present disclosure is intended to cover any variations, uses, or adaptive changes of the present disclosure that follow the general principles of the present disclosure and include common knowledge or customary technical means in the art that are not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes can be made without departing from its scope. The scope of the present disclosure is limited only by the appended claims.

The term “one embodiment”, “embodiment” or “one or more embodiments” referred to in this specification means that specific features, structures or characteristics described in conjunction with the embodiments are included in at least one embodiment of the present disclosure. Furthermore, please note that the word “in one embodiment” may not necessarily refer to the same embodiment.

In the specification provided here, a large number of specific details are explained However, it can be understood that the embodiments of the present disclosure can be practiced without these specific details. In some examples, well-known methods, structures, and techniques are not shown in detail to avoid blurring the understanding of this specification.

In the claims, any reference symbols located between parentheses should not be constructed as limitations on the claims. The word “comprising” does not exclude the existence of elements or steps that are not listed in the claims. The word “a/an” or “one” before the component does not exclude the existence of multiple such components. The present disclosure can be implemented by means of hardware including several different components and by means of appropriately programmed computers. In the unit claims listing several devices, several of these devices may be specifically embodied through the same hardware item. The use of words such as first, second, and third does not indicate any order. These words can be interpreted as names.

Finally, it should be noted that the above embodiments are only used to illustrate the technical solution of the present disclosure and not to limit it. Although the present disclosure has been described in detail with reference to the aforementioned embodiments, those skilled in the art should understand that they can still modify the technical solutions described in the aforementioned embodiments, or equivalently replace some of the technical features. And these modifications or substitutions do not depart from the essence and scope of the corresponding technical solutions of the embodiments in the present disclosure.

1. An image restoration method, comprising:
for a plurality of consecutive frames of images of a target video, acquiring an optical flow image between an image to be restored and each of a plurality of reference images; wherein the plurality of reference images comprise at least a previous frame image and a next frame image that are adjacent to the image to be restored;
based on the optical flow image between each of the plurality of reference images and the image to be restored, performing motion estimation from the reference image to a moment of the image to be restored, to obtain a motion estimation image; and
restoring defects of the image to be restored based on motion estimation images respectively corresponding to the plurality of reference images, to obtain a restored target image; wherein the defects comprise at least a defect of a bad pixel type.

2. The image restoration method according to claim 1, comprising:
extracting feature maps of each of the plurality of reference images under a plurality of receptive fields, and transforming the feature maps under each of the plurality of receptive fields based on the optical flow image between the reference image and the image to be restored, to obtain inter-frame semantic features under the plurality of receptive fields;
wherein restoring defects of the image to be restored based on motion estimation images respectively corresponding to the plurality of reference images, to obtain a restored target image comprises:
restoring the image to be restored based on the motion estimation images and the inter-frame semantic features respectively corresponding to the plurality of reference images, to obtain the target image.

3. The image restoration method according to claim 2, wherein restoring the image to be restored based on the motion estimation images and the inter-frame semantic features respectively corresponding to the plurality of reference images, to obtain the target image comprises:
performing feature fusion on the image to be restored and the motion estimation images respectively corresponding to the plurality of reference images, to restore the defects of the image to be restored and obtain a coarse restored feature map; and
performing feature correction on the coarse restored feature map based on the inter-frame semantic features respectively corresponding to the plurality of reference images, to obtain the target image.

4. The image restoration method according to claim 2, wherein transforming the feature maps under each of the plurality of receptive fields based on the optical flow image between the reference image and the image to be restored, to obtain inter-frame semantic features under the plurality of receptive fields comprises:
processing the optical flow image corresponding to the reference image at a plurality of scales, to obtain a sub-optical flow image corresponding to each of the plurality of scales; wherein different scales correspond to different receptive fields; and
mapping the feature maps under a corresponding receptive field based on the sub-optical flow image corresponding to each of the plurality of scales, to obtain the inter-frame semantic features.

5. The image restoration method according to claim 3, wherein performing feature correction on the coarse restored feature map based on the inter-frame semantic features respectively corresponding to the plurality of reference images, to obtain the target image comprises:
acquiring a plurality of inter-frame semantic features belonging to the same receptive field from the inter-frame semantic features respectively corresponding to the plurality of reference images; and
correcting the coarse restored feature map under the plurality of receptive fields based on a plurality of inter-frame semantic features respectively corresponding to the plurality of receptive fields, to obtain the target image.

6. The image restoration method according to claim 5, wherein correcting the coarse restored feature map under the plurality of receptive fields based on a plurality of inter-frame semantic features respectively corresponding to the plurality of receptive fields, to obtain the target image comprises:
iteratively performing first feature fusion multiple times in an order of preset sizes of the receptive fields, until the plurality of inter-frame semantic features of all receptive fields are fused, to obtain a second fusion feature; and
acquiring the target image based on the second fusion feature;
wherein in the first feature fusion of each time, performing feature fusion on the plurality of inter-frame semantic features of the receptive field corresponding to the first feature fusion of a current time and first fusion features outputted after performing the first feature fusion of a previous time.

7. The image restoration method according to claim 6, wherein acquiring the target image based on the second fusion feature comprises:
acquiring a part or all of the first fusion features, each of the first fusion features corresponding to one receptive field; and
iteratively performing second feature fusion, to obtain the target image; wherein when performing the second feature fusion each time, fusing features outputted after performing the second feature fusion of a previous time and the first fusion features under the receptive field corresponding to the second feature fusion of a current time.

8. The image restoration method according to claim 7, wherein in the first feature fusion of two adjacent times, a size of the receptive field targeted by the first feature fusion of the previous time is less than a size of the receptive field targeted by the first feature fusion of a next time; and
in the second feature fusion of every two times, a size of the receptive field targeted by the second feature fusion of the previous time is greater than a size of the receptive field targeted by the second feature fusion of a next time.

9. The image restoration method according to claim 1, wherein acquiring an optical flow image between an image to be restored and each of a plurality of reference images comprises:
inputting the plurality of reference images and the image to be restored into an optical flow network, and outputting the optical flow image between the image to be restored and each of the plurality of reference images by the optical flow network.

10. The image restoration method according to claim 1, further comprising:
restoring bad pixels in the image to be restored based on the plurality of reference images, to obtain a bad pixel restored image;
wherein restoring defects of the image to be restored based on motion estimation images respectively corresponding to the plurality of reference images, to obtain a restored target image, comprises:
restoring the bad pixel restored image based on the motion estimation images respectively corresponding to the plurality of reference images, to obtain the target image.

11. The image restoration method according to claim 10, wherein restoring bad pixels in the image to be restored based on the plurality of reference images, to obtain a bad pixel restored image comprises:
based on defect-free areas in the previous frame_image and the next frame_image that are adjacent to the image to be restored among the plurality of reference images, restoring an area corresponding to the defect-free areas in the image to be restored, to obtain the bad pixel restored image.

12. The image restoration method according to claim 1, wherein restoring defects of the image to be restored based on motion estimation images respectively corresponding to the plurality of reference images, to obtain a restored target image comprises:
restoring the defects of the image to be restored based on the plurality of reference images and the motion estimation images respectively corresponding to the plurality of reference images, to obtain the target image.

13. The image restoration method according to claim 1, wherein acquiring an optical flow image between an image to be restored and each of a plurality of reference images comprises:
inputting the image to be restored and the plurality of reference images into an optical flow network of an image restoration model, and outputting the optical flow image between the image to be restored and each of the plurality of reference images by the optical flow network;
wherein restoring defects of the image to be restored based on motion estimation images respectively corresponding to the plurality of reference images, to obtain a restored target image, comprises:
inputting the image to be restored and the motion estimation images respectively corresponding to the plurality of reference images into a generative network of the image restoration model, to restore the defects of the image to be restored, to obtain the target image.

14. The image restoration method according to claim 2, wherein extracting feature maps of each of the plurality of reference images under a plurality of receptive fields, and transforming the feature maps under each of the plurality of receptive fields based on the optical flow image between the reference image and the image to be restored, to obtain inter-frame semantic features under the plurality of receptive fields comprises:
inputting each of the plurality of reference images and the optical flow image corresponding to the reference image into a semantic network of an image restoration model, extracting the feature maps of the reference image under the plurality of receptive fields by the semantic network, and transforming the feature maps under each of the plurality of receptive fields based on the optical flow image, to obtain the inter-frame semantic features under the plurality of receptive fields;
wherein restoring defects of the image to be restored based on motion estimation images respectively corresponding to the plurality of reference images, to obtain a restored target image comprises:
inputting the image to be restored, as well as the motion estimation images and the inter-frame semantic features respectively corresponding to the plurality of reference images into a generative network of the image restoration model, to restore the defects of the image to be restored, to obtain the target image.

15. The image restoration method according to claim 14, wherein the generative network comprises a feature concatenation module, as well as a primary fusion module and a secondary fusion module that are sequentially connected in series after the feature concatenation module; wherein the primary fusion module comprises a plurality of first fusion units that are connected in series;
the feature concatenation module is configured for performing feature fusion on the image to be restored and the motion estimation images respectively corresponding to the plurality of reference images, to obtain a coarse restored feature map;
each of the plurality of first fusion units is configured for performing the feature fusion on a plurality of inter-frame semantic feature under one receptive field and a first fusion feature outputted by a previous first fusion unit; wherein different first fusion units correspond to the plurality of inter-frame semantic features under different receptive fields; and
the secondary fusion module is configured for outputting the target image based on a second fusion feature.

16. The image restoration method according to claim 15, wherein the secondary fusion module comprises a plurality of second fusion units that are sequentially connected in series, wherein an input end of one second fusion unit is connected to output ends of a previous second fusion unit and one first fusion unit;
each of the plurality of second fusion units is configured for fusing features outputted by the previous second fusion unit and the first fusion feature outputted by the corresponding first fusion unit, and inputting into a next second fusion unit; and
the last one of the plurality of second fusion units is configured for outputting the target image.

17. The image restoration method according to claim 14, wherein the semantic network comprises: a convolution module and a downsampling module; wherein the convolution module comprises a plurality of convolution units that are sequentially connected in series, and the downsampling module comprises a plurality of downsampling units; wherein
each of the plurality of convolution units is configured for performing feature extraction on features outputted by a previous convolution unit, wherein each of the plurality of convolution units is configured for performing the feature extraction on the reference image and inputting extracted feature maps into a corresponding downsampling unit; wherein different convolution units connect to different downsampling units, and different convolution units correspond to different receptive fields; and
each of the plurality of downsampling units is configured for performing a downsampling operation on the optical flow image at a corresponding scale to obtain a sub-optical flow image based on the downsampling operation, and transforming the feature maps outputted by the corresponding convolution unit to obtain the inter-frame semantic feature.

18. (canceled)

19. An electronic device, comprising a memory, a processor, and a computer program stored on the memory and executable on the processor, wherein the computer program, when executed by the processor, implements the image restoration method according to claim 1.

20. A non-transitory computer-readable storage medium, wherein a computer program stored thereon causes a processor to execute the image restoration method according to claim 1.

21. The electronic device according to claim 19, wherein the computer program, when executed by the processor, further implements operations comprising:
extracting feature maps of each of the plurality of reference images under a plurality of receptive fields, and transforming the feature maps under each of the plurality of receptive fields based on the optical flow image between the reference image and the image to be restored, to obtain inter-frame semantic features under the plurality of receptive fields;
wherein the operation of restoring defects of the image to be restored based on motion estimation images respectively corresponding to the plurality of reference images, to obtain a restored target image comprises:
restoring the image to be restored based on the motion estimation images and the inter-frame semantic features respectively corresponding to the plurality of reference images, to obtain the target image.
